(19) United States
(12) Patent Application Publication
(10) Pub. No.: US 2022/0157124 A1
(43) Pub. Date: May 19, 2022

(54) GAMING MACHINE

(71) Applicant: SAMMY CORPORATION, Shinagawa-ku (JP)

(72) Inventors: Takaya YONEDA, Shinagawa-ku (JP); Shinya OHTANI, Shinagawa-ku (JP); Yusuke HASHIMOTO, Shinagawa-ku (JP); Teppei HIGASHI, Shinagawa-ku (JP); Taiji SUGAI, Shinagawa-ku (JP); Jun NISHIOKA, Shinagawa-ku (JP); Kazuaki UTSUNOMIYA, Shinagawa-ku (JP); Hiroyuki ITO, Shinagawa-ku (JP)

(73) Assignee: SAMMY CORPORATION, Shinagawa-ku (JP)

(21) Appl. No.: 17/439,487

(22) PCT Filed: Mar. 25, 2019
(86) PCT No.: PCT/JP2019/012627

§ 371 Date: Sep. 15, 2021

(51) Int. Cl. G07F 17/32

(52) U.S. Cl. CPC G07F 17/3262; G07F 17/3267; G07F 17/3213

(57) ABSTRACT

The present invention provides a gaming machine that can allow active participation in a game without loss of interest even in the midst of a free game. The present invention includes: an operation reception device that receives an operation by a player; a display that scrolls a video reel on which a plurality of symbols are aligned, and then display a game result by rearranging the plurality of symbols; and a controller that executes a base game and a plurality of chance games that require betting, and a plurality of free games that require no betting. The controller executes, during execution of a free game, a skill game in which a video reel being scrolled is stopped in accordance with an operation by a player on the operation reception device.

### TECHNICAL FIELD

The present invention relates to a gaming machine that shifts from a base game to an advantageous game such as a free game.

### BACKGROUND ART

There has been a gaming machine provided with a free game that is more advantageous than a base game (see, for example, Patent Literature 1, Patent Literature 2, Patent Literature 3, and Patent Literature 4). By shifting to such a free game, a player has been able to play the game in a more advantageous state than the base game.

### CITATION LIST

### Patent Literature

Patent Literature 1: US 2012/184369 A
Patent Literature 2: US 2013/196741 A
Patent Literature 3: US 2016/005260 A
Patent Literature 4: JP 2016-158676 A

### SUMMARY OF INVENTION

### Technical Problem

Although the free game causes an advantageous state, the player may have got bored in the middle of the game since the game automatically progresses without any operation.

The present invention has been made in view of the above point, and an object is to provide a gaming machine capable of allowing a player to actively participate without getting bored even in the middle of a free game.

### Solution to Problem

A feature of a gaming machine according to the present invention is to include:

an operation reception device configured to receive an operation by a player;

a display configured to display a game result by scrolling a video reel on which a plurality of symbols are aligned, and then rearranging the plurality of symbols; and

a controller configured to execute a base game and a plurality of chance games that require betting, and a plurality of free games that require no betting, in which

the controller executes, during execution of the free game, a skill game in which a video reel being scrolled is stopped in accordance with an operation by a player on the operation reception device.

### BRIEF DESCRIPTION OF DRAWINGS

FIG. 1 is a front view illustrating an appearance of a gaming machine 10 according to the present embodiment.

FIG. 2 is a block diagram illustrating a main hardware configuration of the gaming machine 10.

FIG. 3 is a table showing an example of a symbol table.

FIG. 4 is a payout table showing a correspondence relationship between a winning combination and a payout (hereinafter referred to as a normal payout).

FIG. 5 is a diagram illustrating a transition of a game to be executed in the gaming machine 10.

FIG. 6 is a flowchart illustrating normal game processing called and executed in a normal game.

FIG. 7 is a flowchart illustrating BET processing and SPIN button processing.

FIG. 8 is a symbol table selection table for selecting a symbol table in the normal game.

FIG. 9 is a flowchart illustrating lottery processing.

FIG. 10 is a flowchart illustrating stop symbol lottery processing.

FIG. 11A is a view illustrating game shift lottery table 1.

FIG. 11B is a view illustrating game shift lottery table 2.

FIG. 11C is a view illustrating game shift lottery table 3.

FIG. 12 is a flowchart showing re-spinning determination processing.

FIG. 13 is a numeral table of re-spinning lottery processing 1.

FIG. 14 is a numeral table of re-spinning lottery processing 1.

FIG. 15A is a numeral table of re-spinning lottery processing 2.

FIG. 15B is a numeral table of re-spinning lottery processing 3.

FIG. 16 is a flowchart illustrating scroll display control processing.

FIG. 17 is a flowchart illustrating discharge number determination processing.

FIG. 18 is a flowchart illustrating the discharge number determination processing.

FIG. 19 is a flowchart illustrating free game processing.

FIG. 20A is a flowchart illustrating free game start processing.

FIG. 20B is a flowchart illustrating skill chance lottery processing.

FIG. 21 is a numeral table showing a likelihood of winning or non-winning of a skill chance.

FIG. 22 is a flowchart illustrating multi-feature processing.

FIG. 23 is a multi-feature numeral table showing an example of numerals for determining a likelihood of winning (or a likelihood of non-winning) of a multi-feature in multi-feature lottery processing.

FIG. 24 is a numeral table of multi-feature allocation lottery processing.

FIG. 25 is a numeral table of the multi-feature allocation lottery processing.

FIG. 26 is a time chart illustrating an outline of a skill game.

FIG. 27 is a flowchart illustrating game shift processing.

FIG. 28 is a flowchart illustrating JACKPOT accumulation processing.

FIG. 29A is a view illustrating a storage area used in the JACKPOT accumulation processing.

FIG. 29B is a view illustrating a storage area used in the JACKPOT accumulation processing.

### DESCRIPTION OF EMBODIMENTS

### Outline of Present Embodiment

### <<<Aspect 1 and 2>>>

There is a gaming machine provided with a free game that is more advantageous than a base game. By shifting to such a free game, a player can play the game in a more advantageous state than the base game.

Since the free game is a game that can be played without consuming credits, there is a possibility of excessively giving a player a profit depending on conditions and the like for shifting to the free game.

### <<Aspect 1-1>>

According to Aspect 1-1, there is provided a gaming machine including:

a display configured to display a game result by scrolling a video reel including a plurality of symbols and then rearranging the plurality of symbols; and

a controller configured to execute a base game and a plurality of chance games that require betting, and a plurality of free games that require no betting, in which

the controller causes a shift from a first chance game among the plurality of chance games to a first free game among the plurality of free games when a first shift condition is satisfied,

causes a shift from a second chance game among the plurality of chance games to a second free game among the plurality of free games when a second shift condition different from the first shift condition is satisfied, and

sets a probability of establishment of the second shift condition to be higher than a probability of establishment of the first shift condition.

The gaming machine includes the display and the controller.

The display displays a game result. The game result is obtained by scrolling the video reel and then rearranging the plurality of symbols. The plurality of symbols are arranged in the video reel.

The controller executes the base game, the plurality of chance games, and the plurality of free games. The base game and the plurality of chance games are games that require betting. The plurality of free games are games that do not require betting.

The controller is configured to:

(1-1-1) cause a shift from a first chance game among the plurality of chance games to a first free game among the plurality of free games when a first shift condition is satisfied,

(1-1-2) cause a shift from a second chance game among the plurality of chance games to a second free game among the plurality of free games when a second shift condition different from the first shift condition is satisfied, and

(1-1-3) set a probability of establishment of the second shift condition to be higher than a probability of establishment of the first shift condition.

A probability of establishment of the second shift condition for shifting to the second free game is made higher than a probability of establishment of the first condition for shifting to the first free game. Therefore, by providing a difference in a likelihood of shifting to the first free game and shifting to the second free game, it is possible to appropriately adjust a payout that can be earned by the player in the free game, prevent an excessive payout to the player in the free game, and achieve a balance between a profit of the player and a profit of a gaming facility such as a casino.

### <<Aspect 1-2>>

According to Aspect 1-2, in Aspect 1-1,

the controller causes

a shift to the first chance game when the second free game ends, and

a shift to the second chance game when the first free game ends.

By causing a shift to a chance game that is different from the original chance game, it is possible to prevent a flow of the game from becoming monotonous and to finely adjust the payout that can be earned by the player.

### <<Aspect 1-3>>

According to Aspect 1-3, in Aspect 1-1,

the controller causes

a probability of shifting from the first free game to the second free game through the second chance game to be higher than a probability of shifting from the second free game to the first free game through the first chance game.

The shift from the first free game to the second free game through the second chance game is made easy, while the shift from the second free game to the first free game through the first chance game is made difficult. Therefore, it is possible to provide difficulty in continuity of the game, prevent the flow of the game from becoming monotonous, make the flow of the game interesting, and also adjust a payout.

### <<Aspect 1-4>>

According to Aspect 1-4, in Aspect 1-1,

the controller,

while each of the plurality of chance games includes a plurality of times of a unit game,

performs, in one unit game, at least one re-scrolling including: temporarily stopping a video reel after scrolling; scrolling a video reel again and then stopping; and rearranging the plurality of symbols,

sets a probability of re-scrolling in each of the plurality of chance games to be higher than a probability of re-scrolling in a base game, and

increases a probability of shifting from the chance game to one free game at every re-scrolling.

The re-scrolling can gradually increase expectation of shifting to the free game, and attract the player to the game.

### <<Aspect 1-5>>

Aspect 1-5 further includes, in Aspect 1-1,

a credit output device configured to output a credit, in which

the controller

permits output of a credit from the credit output device in the base game and the chance game, and

prohibits output of the credit from the credit output device in the free game.

It is possible to prevent cash-out of the credit when the free game is being executed, and to simplify the processing.

### <<Aspect 1-6>>

According to Aspect 1-6, in Aspect 1-3,

the controller

displays a payout obtained in the first free game or the second free game on the display, when executing the first free game or the second free game a plurality of times and then shifting to the base game through the first chance game or the second chance game.

The player can visually recognize the payout that can be earned by the player, and can feel a sense of fulfillment.

### <<Aspect 2-1>>

According to Aspect 2-1, in Aspect 1-1,

when a third shift condition that is different from the first shift condition and different from the second shift condition is satisfied, a shift is made from a third chance game among the plurality of chance games to a third free game among the plurality of free games, and

a probability of establishment of the third shift condition is set higher than a probability of establishment of the first shift condition and a probability of establishment of the second shift condition.

### <<Aspect 2-2>>

According to Aspect 2-2, in Aspect 2-1,

the controller causes

a shift to the first chance game when the second free game ends,

a shift to the second chance game when the first free game ends, and

a shift to the third chance game when the third free game ends.

By providing the third shift condition to be higher in probability of establishment than the first shift condition and the second shift condition, it is possible to further enhance the player's expectation, and causes the game to be continued.

Furthermore, according to Aspect 2, there is provided a gaming machine including:

a display configured to display a game result by scrolling a video reel including a plurality of symbols and then rearranging the plurality of symbols; and

a controller configured to execute a base game and a plurality of chance games that require betting, and a plurality of free games that require no betting, in which

the controller causes a shift from a first chance game among the plurality of chance games to a first free game among the plurality of free games when a first shift condition is satisfied,

causes a shift from a second chance game among the plurality of chance games to a second free game among the plurality of free games when a second shift condition different from the first shift condition is satisfied,

causes a shift from a third chance game among the plurality of chance games to a third free game among the plurality of free games when a third shift condition that is different from the first shift condition and different from the second shift condition is established,

sets a probability of the second shift condition to be higher than a probability of establishment of the first shift condition, and

sets a probability of establishment of the third shift condition to be higher than a probability of establishment of the first shift condition and a probability of establishment of the second shift condition.

### <<Aspect 2-3>>

According to Aspect 2-3, in Aspect 2-1,

a probability of shifting from the third free game to the third free game through the third chance game is higher than a probability of shifting from the first free game to the second free game through the second chance game and a probability of shifting from the second free game to the first free game through the first chance game.

In addition to shifting from the first free game to the second free game through the second chance game and shifting from the second free game to the first free game through the first chance game, it is possible to provide a path for shifting between the third free game and the third chance game, further enhance the player's expectation, and cause the game to be continued.

### <<<Aspect 3>>>

In the gaming machine, the base game requiring betting and the free game not requiring betting are executed. By shifting to the free game, the player can play the game in a more advantageous state than the base game. Since the game automatically progresses without any operation in the free game, there has been a possibility that the player gets bored in the middle of the game.

### <<Aspect 3-1>>

According to Aspect 3-1, there is provided a gaming machine including:

an operation reception device configured to receive an operation by a player;

a display configured to display a game result by scrolling a video reel on which a plurality of symbols are aligned, and then rearranging the plurality of symbols; and

a controller configured to execute a base game and a plurality of chance games that require betting, and a plurality of free games that require no betting, in which

the controller executes, during execution of the free game, a skill game in which a video reel being scrolled is stopped in accordance with an operation by a player on the operation reception device.

Since the video reel being scrolled is stopped in accordance with an operation by the player, it is possible to cause the player to actively participate in the game while allowing the player to feel tension and expectation.

### <<Aspect 3-2>>

Aspect 3-2 further includes, in Aspect 3-1,

a memory that stores reel data of a normal video reel for stop-display of a normal symbol and reel data of a specific video reel for stop-display of a specific symbol different from the normal symbol, the specific video reel being for stop-display of the specific symbol without depending on a timing of an operation by a player on an operation reception device, in which

each of the plurality of free games includes a plurality of times of a unit game, and

the skill game is a game of:

switching to the specific video reel and scrolling the specific video reel on condition that, in one unit game in a free game, the specific symbol stop-displayed when the normal video reel is temporarily stopped after being scrolled is in a predetermined alignment, and then stopping the specific video reel in accordance with an operation by a player on the operation reception device and rearranging the plurality of symbols to establish a winning combination of the specific symbol.

Since the specific symbol is stop-displayed without depending on a timing of an operation by the player, it is possible to allow the player to participate in the game without depending on a skill level of the player, and it is possible to make the player feel a sense of accomplishment and prevent the player from getting bored.

### <<Aspect 3-3>>

According to Aspect 3-3, in Aspect 3-1,

the specific symbol includes a normal specific symbol having a normal form and a special specific symbol having a special form, and

in a skill game,

when a winning combination of only the normal specific symbol is established, a first payout is granted, and

when a winning combination of the special specific symbol and the normal specific symbol is established, a second payout more advantageous than the first payout is granted.

Depending on a skill level of the player, it is possible to stop the special specific symbol to obtain an advantageous payout, so that the player can actively participate in the game so as to increase the skill level.

### <<Aspect 3-4>>

According to Aspect 3-4, in Aspect 3-1,

whether or not to execute the skill game is selected by an operation by the player on the operation reception device.

The game can be executed while the player's intention is reflected.

### <<<Aspect 4>>>

There is a gaming machine having a jackpot function. When a player wins the jackpot, the player also obtains a payout of the jackpot in addition to a normal payout, and thus advances the game while expecting to win the jackpot.

The jackpot is a function of accumulating an added value for accumulation by adding to a bet accumulation value as the game progresses, and discharging the accumulated bet accumulation value when the jackpot is won. In a case where the added value for accumulation is kept constant to be accumulated, there is a possibility of causing unfairness in the bet accumulation value to be discharged depending on magnitude of a BET rate.

### <<Aspect 4-1>>

According to Aspect 4-1, there is provided a gaming machine including:

a bet receiving device configured to receive a bet for starting a game;

a memory having a plurality of accumulation value storage areas allocated in accordance with a number of bets; and

a controller configured to calculate a bet accumulation value accumulated by adding an added value that is a part of a number of bets received by the bet receiving device, and store the bet accumulation value in at least one accumulation value storage area, in which the controller selects at least one accumulation value storage area from the plurality of accumulation value storage areas in accordance with a number of bets when a discharge condition of a jackpot is established, and discharges a sum of bet accumulation values stored in the selected accumulation value storage area.

The memory has a plurality of accumulation value storage areas allocated in accordance with a number of bets. Moreover, a bet accumulation value accumulated by adding an added value that is a part of a number of bets is calculated, and the bet accumulation value is stored in at least one accumulation value storage area. Further, when the jackpot is discharged, at least one accumulation value storage area is selected from the plurality of accumulation value storage areas in accordance with a number of bets, and a sum of bet accumulation values stored in the selected accumulation value storage area is discharged.

In this manner, since the bet accumulation value is accumulated in accordance with the number of bets, and at least one accumulation value storage area is selected in accordance with the number of bets, an appropriate bet accumulation value can be discharged to the player without depending on magnitude of the number of bets.

### <<Aspect 4-2>>

According to Aspect 4-2, in Aspect 4-1,

each of the plurality of accumulation value storage areas is a plurality of distribution storage areas to which a distribution ratio is allocated, and

the controller calculates a new bet accumulation value by adding a distributed added value obtained by distributing the added value in accordance with a distribution ratio to the bet accumulation value already stored in each of the plurality of distribution storage areas, and causes the plurality of distribution storage areas to store the calculated bet accumulation value.

Since the bet accumulation value is stored in each of the plurality of distribution storage areas, it is possible to more finely store the bet accumulation value in accordance with the number of bets, and it is possible to more accurately eliminate unfairness caused between players.

### <<Aspect 4-3>>

According to Aspect 4-3, in Aspect 4-1,

the controller causes one of the plurality of accumulation value storage areas to store the bet accumulation value.

Since the bet accumulation value is stored in one of the plurality of accumulation value storage areas, the processing can be simplified.

### <<Aspect 4-4>>

According to Aspect 4-4, in Aspect 4-1,

when a jackpot discharging condition is established, the controller

discharges a bet accumulation value stored in one accumulation value storage area among the plurality of accumulation value storage areas in a case where a number of bets is minimum, and

discharges a bet accumulation value stored in accumulation value storage areas of a number corresponding to the number of bets among the plurality of accumulation value storage areas, in a case where the number of bets is larger than the minimum.

Since the bet accumulation value is discharged in accordance with magnitude of the number of bets, it is possible to eliminate unfairness caused between players.

### <<<Aspect 5>>>

In a gaming machine, a base game and a chance game that require betting and a free game that requires no betting are executed. The player starts the game by betting in the base game and the chance game. Whereas, in the free game, the player starts the game without betting.

The free game maintains a number of bets of the base game and the chance game before shifting to the free game. Therefore, in a case where the game is played with the number of bets increased in the base game and the chance game, the number of bets is also increased in the free game. Whereas, in a case where the game is played with the number of bets reduced in the base game and the chance game, the number of bets is also reduced in the free game.

In addition, in the base game and the chance game, the number of bets can be changed in the middle. Therefore, in a case where a shift is made to the free game with the number of bets reduced in the base game and the number of bets increased in the chance game, there is a possibility that a payout will be unreasonably increased. In a case where a shift is made to the free game with the number of bets increased in the base game and the number of bets decreased in the chance game, there is a possibility that a payout will be unreasonably reduced.

### <<Aspect 5-1>>

According to Aspect 5-1, there is provided a gaming machine including:

a bet receiving device configured to receive a bet for starting a game;

a memory that stores a history number of bets indicating a history of a number of bets; and

a controller configured to execute a base game and a plurality of chance games that require betting, and a plurality of free games that require no betting, in which the controller

causes a shift from the base game to one chance game among the plurality of chance games when a first shift condition is satisfied,

causes a shift from the base game or the chance game to one free game among a plurality of free games when a second shift condition different from the first shift condition is satisfied, and

adjusts a payout that can be earned in the chance game or the free game in accordance with the history number of bets in the base game and the number of bets in the chance game.

The bet receiving device receives a bet for starting a game. The bet receiving device can receive an operation by the player.

A payout that can be earned in the chance game or the free game is adjusted in accordance with the history number of bets in the base game and the number of bets in the chance game. In this way, even when the number of bets is changed between the base game and the chance game, a payout can be fairly granted so that there is no unfairness in the payout.

### <<Aspect 5-2>>

According to Aspect 5-2, in Aspect 5-1,

the controller

performs adjustment such that a payout that can be earned in the chance game is reduced in a case where the number of bets in the chance game is larger than the history number of bets in the base game, and

performs adjustment such that a payout that can be earned in the chance game is increased in a case where the number of bets in the chance game is smaller than the history number of bets in the base game.

Even when the number of bets is changed between the base game and the chance game, a payout can be fairly granted so that there is no unfairness in the payout.

### <<Aspect 5-3>>

According to Aspect 5-3, in Aspect 5-1,

the controller

performs adjustment such that a payout that can be earned in the free game is reduced in a case where the number of bets in the chance game is larger than the history number of bets in the base game, and

performs adjustment such that a payout that can be earned in the chance game is increased in a case where the number of bets in the chance game is smaller than the history number of bets in the base game.

Even when the number of bets is changed between the base game and the chance game, a payout can be fairly granted so that there is no unfairness in the payout.

### <<Aspect 5-4>>

According to Aspect 5-4, in Aspect 5-1,

the controller

performs adjustment such that a number of games in the chance game is reduced in a case where the number of bets in the chance game is larger than the history number of bets in the base game, and

performs adjustment such that the number of games in the chance game is increased in a case where the number of bets in the chance game is smaller than the history number of bets in the base game.

Even when the number of bets is changed between the base game and the chance game, a payout can be fairly granted so that there is no unfairness in the payout.

### <<Aspect 5-5>>

According to Aspect 5-5, in Aspect 5-1,

the controller causes the memory to store an average value of the number of bets in the base game, as the history number of bets.

Since the determination is made on the basis of the average value of the number of bets, the processing can be simplified, and the change in the number of bets can be accurately determined.

### <<Aspect 5-6>>

According to Aspect 5-6, in Aspect 5-4,

in a case where the number of games of the chance game after adjustment is not an integer value, the controller determines whether or not to add and execute one game on the basis of the history number of bets.

Even when the number of games of the chance game is not an integer value, it is possible to perform accurate adjustment by determining whether or not to execute one game, and prevent disadvantageous to the player.

### <<Aspect 5-7>>

According to Aspect 5-7, in Aspect 5-6,

the controller

determines a management counter value for management of the number of games on the basis of the history number of bets,

calculates the number of games in the chance game from the management counter value,

subtracts 1 from the number of games every time one game is played in the chance game, and

determines whether or not to add one game in lottery processing when the number of games is less than 1.

Even when the number of games of the chance game is not an integer value, it is possible to perform accurate adjustment by determining whether or not to execute one game, and prevent disadvantageous to the player.

### Details of Present Embodiment

### Description of Terms

### <Scrolling (Spinning)>

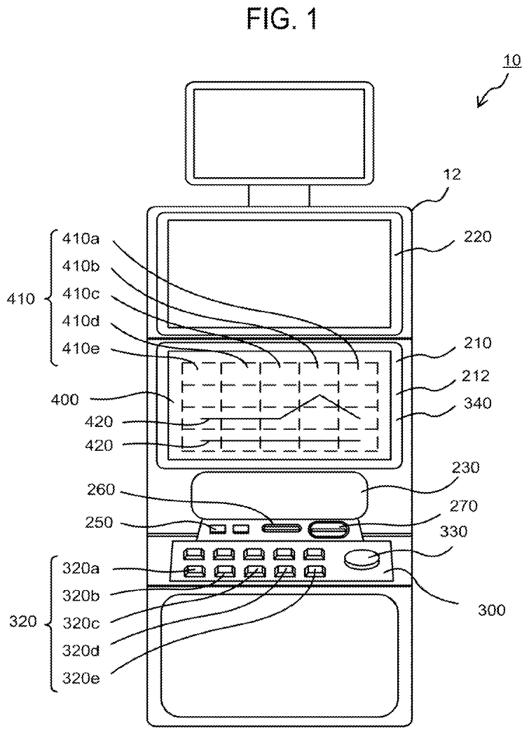

Scrolling means display by moving video reels 410a to 410e (see FIG. 1) in a symbol display area 400. By scrolling a video reel 410, symbols assigned to the video reel 410 are also displayed so as to move in the symbol display area 400. In general, the scrolling is performed from an upper side to a lower side in principle, but may be performed from the lower side to the upper side in accordance with a type of a game, presentation, or the like. Note that spinning is synonymous with the scrolling.

### <Re-Scrolling (Re-Spinning)>

Re-scrolling is processing of once stopping the scrolled video reels 410a to 410e in the symbol display area 400 and then scrolling again, in one unit game. Note that it is not necessary to re-scroll all the video reels 410a to 410e, and any one video reel 410 can be selectively re-scrolled in accordance with a result of symbol lottery processing or the like. Note that re-spinning is synonymous with the re-scrolling.

### <Stop-Display>

Stop-display refers to processing of displaying a symbol in a stopped state at each of stop positions in the symbol display area 400 when the video reels 410a to 410e are stopped.

### <Rearrangement>

Rearrangement means stopping the video reels 410a to 410e and stop-displaying a symbol in the symbol display area 400. The rearrangement is a state where arrangement of the symbols is once released by scrolling the video reels 410a to 410e, and then the symbols are arranged again.

### <Unit Game>

In both a normal game and a free game described later, a period from when BET processing is executed to when the video reels 410a to 410e are stopped and discharge processing is ended is referred to as a unit game. The BET processing is internal processing, and is different from a BET operation by the player. Note that, in particular, in a case of the free game, the unit game may be a period from when scrolling of the video reels 410a to 410e is started to when the video reels 410a to 410e are stopped and the discharge processing is ended.

### <Winning Combination>

A winning combination refers to an alignment in which an alignment of symbols stop-displayed along a pay line 420 in the symbol display area 400 is a target of profit granting. Note that, in a case of a scatter symbol to be described later, the winning combination is to be one in which a number of scatter symbols stop-displayed is a predetermined number to be a target of profit granting. Here, the profit granting may be anything that is advantageous to the player, such as case of shifting to an advantageous game, in addition to provision (discharge) of a payout.

### <Scatter Symbol>

The scatter symbol is a symbol for which establishment of the winning combination is determined on the basis of the number of symbols stop-displayed. The scatter symbols are determined on the basis of the number of pieces that are stop-displayed, regardless of whether or not the symbols are aligned along the valid pay line 420.

### <Wild Symbol>

A wild symbol is a symbol that can be substituted for another symbol stop-displayed in the symbol display area 400. When establishment of the winning combination is determined, the establishment of the winning combination is determined by replacing the wild symbol with another symbol. The wild symbol is replaced with another symbol so that an advantageous winning combination is established.

Note that, when the wild symbol is stop-displayed at a stop position that overlaps with a plurality of valid pay lines 420, establishment of the winning combination is determined by replacing the wild symbol for every pay line 420.

### <Shift Continuity>

Shift continuity refers to shifting from the normal game to the free game to be described later (a forward path), and returning from the free game to the normal game (a return path), and shifting again from the normal game to the free game.

### <Skill Game>

A skill game is a game in which an operation skill of the player is reflected in a result of the game. In particular, in the skill game of the present embodiment, the player determines a timing of a stop operation and performs the stop operation (target symbol stop operation) to aim to stop-display a target symbol. The operation skill of the player is reflected in the determination of the timing of the stop operation.

Hereinafter, the present embodiment will be described with reference to the drawings.

### <<<Configuration of Gaming Machine 10>>>

FIG. 1 is a front view illustrating an appearance of a gaming machine 10 according to the present embodiment. The gaming machine 10 is a video slot machine. Similarly to a mechanical slot machine in which a physical reel is driven by a motor or the like, establishment of a winning combination is determined by a symbol stop-displayed in the symbol display area 400. Any device may be adopted as long as a shift can be made from a base game serving as a reference to another game (a game more advantageous for a player than the base game is preferable).

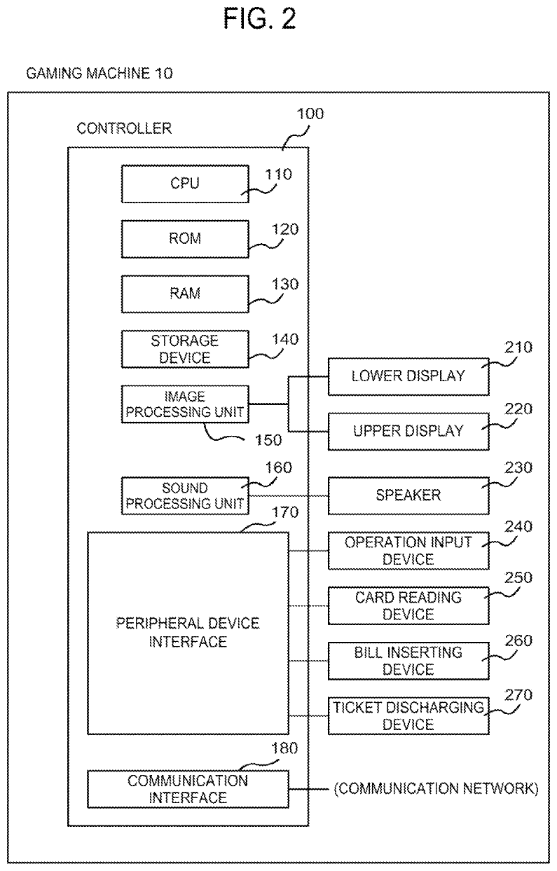

As illustrated in FIG. 1, the gaming machine 10 mainly includes a lower display 210, an upper display 220, a control panel 300, and a controller 100 (FIG. 2).

### <<Lower Display 210>>

The gaming machine 10 has the lower display 210 at approximately a center of a housing 12. The lower display 210 includes, for example, a liquid crystal display panel 212 and a touch panel 340. The touch panel 340 is provided to be superimposed on the liquid crystal display panel 212. When the player touches the touch panel 340, an instruction corresponding to an image displayed on the liquid crystal display panel 212 can be inputted from the touch panel 340.

The lower display 210 further includes a credit number display area and a payout number display area (not illustrated). In the credit number display area, the number of credits owned by the player is displayed. In the payout number display area, the number of credits to be discharged when a predetermined winning combination is established is displayed.

### <<Upper Display 220>>

The gaming machine 10 has the upper display 220 above the lower display 210. The upper display 220 includes a liquid crystal display panel. Various images such as a presentation image are displayed on the upper display 220.

### <<Control Panel 300>>

The gaming machine 10 has the control panel 300 below the lower display 210. The control panel 300 mainly includes a BET button 320, a SPIN button 330, a card reading device 250, a bill inserting device 260, a ticket discharging device 270, and the like.

<BET Button 320 (320a, 320b, 320c, 320d, and 320e)>

The control panel 300 includes a “BET×1” button 320a, a “BET×2” button 320b, a “BET×3” button 320c, a “BET×4” button 320d, and a “BET×5” button 320e. A BET rate is set to 1 when the “BET×1” button 320a is operated by the player, the BET rate is set to 2 when the “BET×2” button 320b is operated, the BET rate is set to 3 when the “BET×3” button 320c is operated, the BET rate is set to 4 when the “BET×4” button 320d is operated, and the BET rate is set to 5 when the “BET×5” button 320e is operated.

Note that, in the following description, each of the five BET buttons 320a to 320e is simply referred to as the BET button 320 in a case where it is not particularly necessary to distinguish each or in a case where each cannot be distinguished.

In addition, by providing a manager mode in the gaming machine 10, the rate assigned to each of the five BET buttons 320a to 320e can be changed through an operation by a store clerk or the like. For example, any one of the following BET patterns A to C can be selected to change the rate.

### <BET Pattern A>

When BET pattern A is selected, a BET rate of 1 is assigned to the BET button 320a, a BET rate of 2 is assigned to the BET button 320b, a BET rate of 3 is assigned to the BET button 320c, a BET rate of 4 is assigned to the BET button 320d, and a BET rate of 5 is assigned to the BET button 320e.

### <BET Pattern B>

When BET pattern B is selected, a BET rate of 1 is assigned to the BET button 320a, a BET rate of 2 is assigned to the BET button 320b, a BET rate of 3 is assigned to the BET button 320c, a BET rate of 5 is assigned to the BET button 320d, a BET rate of 10 is assigned to the BET button 320e.

### <BET Pattern C>

When BET pattern C is selected, a BET rate of 1 is assigned to the BET button 320a, a BET rate of 3 is assigned to the BET button 320b, a BET rate of 5 is assigned to the BET button 320c, a BET rate of 10 is assigned to the BET button 320d, a BET rate of 20 is assigned to the BET button 320e.

### <SPIN Button 330>

The SPIN button 330 can be operated by the player to start scrolling of the video reels 410a to 410e. Note that, as described later, in the gaming machine 10 according to the present embodiment, a skill game is executed. In the skill game, when any one of the video reels 410a to 410e is being scrolled, the SPIN button 330 can be operated to stop the video reel 410 being scrolled.

### <<<Hardware Configuration of Gaming Machine 10>>>

FIG. 2 is a block diagram illustrating a main hardware configuration of the gaming machine 10.

The controller 100 of the gaming machine 10 mainly includes: a central processing unit (CPU) 110, a read only memory (ROM) 120, a random access memory (RAM) 130, a storage device 140, an image processing unit 150, a sound processing unit 160, a peripheral device interface 170, and a communication interface 180. These are connected via an input/output bus (not illustrated) such that various commands and signals can be transmitted and received.

### <CPU 110, ROM 120, RAM 130>

The CPU 110 executes various processes such as arithmetic operation. For example, the CPU 110 reads and executes a game program stored in the storage device 140. The ROM 120 stores firmware and the like of the controller 100, and functions as one of main storage devices of the CPU 110. The RAM 130 functions as one of main storage devices of the CPU 110, and develops and stores a program to be executed by the CPU 110 and temporarily stores a result of arithmetic processing of the CPU 110.

### <Storage Device 140>

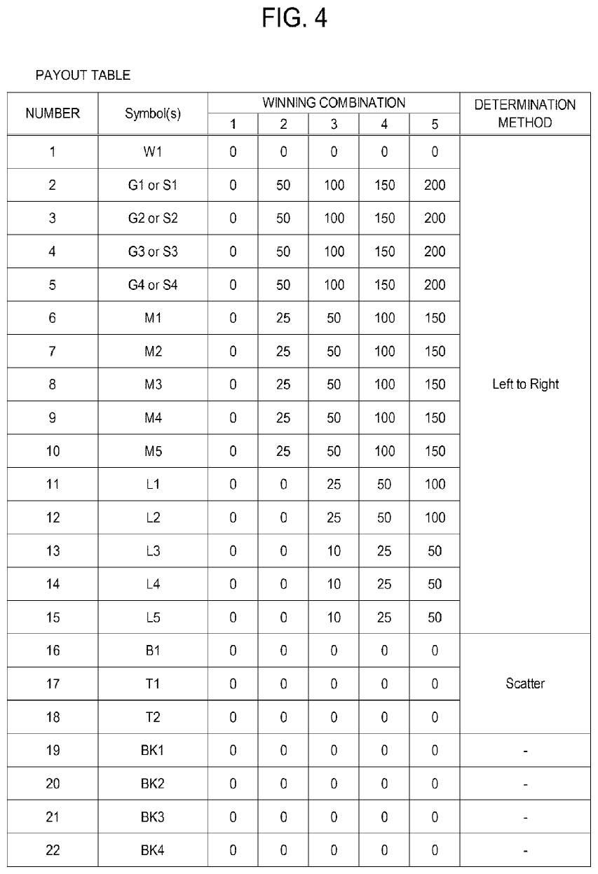

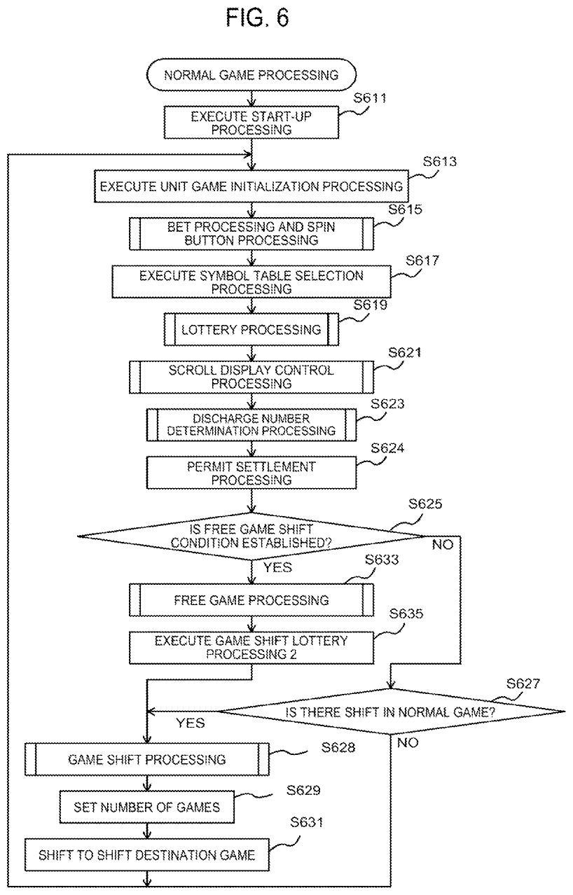

The storage device 140 functions as an auxiliary storage device of the CPU 110, and includes a hard disk drive (HDD), a solid state drive (SSD), a non-volatile memory, and the like. The storage device 140 stores a game program (see FIGS. 6, 7, 8, 10, 12, 16, 17 to 28, and 19 to 22 described later), various tables (such as a payout table of FIG. 4), image data of symbols, image data for presentation, and sound data for presentation.

### <Image Processing Unit 150>

The image processing unit 150 is connected to the lower display 210 and the upper display 220. The CPU 110 outputs various commands and signals to the image processing unit 150. The image processing unit 150 displays various images on the lower display 210 and the upper display 220 in accordance with a command or a signal from the CPU 110. For example, the image processing unit 150 displays images of the video reels 410a to 410e on the lower display 210. In addition, the image processing unit 150 displays images such as various presentation images on the upper display 220.

### <Sound Processing Unit 160>

The sound processing unit 160 is connected to a speaker 230. The CPU 110 outputs various commands and signals to the sound processing unit 160. The sound processing unit 160 supplies a sound signal for presentation to the speaker 230 in accordance with a command or a signal from the CPU 110.

### <Peripheral Device Interface 170>

The peripheral device interface 170 is connected to peripheral devices such as an operation input device 240, the card reading device 250, the bill inserting device 260, and the ticket discharging device 270.

The operation input device 240 includes the BET buttons 320a to 320e, the SPIN button 330, the touch panel 340, and the like. When the player operates the BET buttons 320a to 320e, a signal indicating a BET rate is supplied to the CPU 110 via the peripheral device interface 170. When the player operates the SPIN button 330, a signal indicating spin start permission is supplied to the CPU 110 via the peripheral device interface 170. When the player operates the touch panel 340, a command or the like associated with an image displayed on the liquid crystal display panel 212 is supplied to the CPU 110 via the peripheral device interface 170.

The card reading device 250 reads information from a card owned by the player. The card stores play information of the player. For example, a point or the like earned with the player's gaming situation is stored. The bill inserting device 260 reads an inputted bill and ticket. The ticket discharging device 270 outputs a ticket to be granted to a player. On the ticket, the number of credits owned by the player is printed.

The gaming machine 10 can use bills, tickets, and electronic valuable information corresponding to these, as a game medium. The game medium is not limited to this, and for example, a medal, a token, electronic money, or the like can also be used.

### <Communication Interface 180>

The communication interface 180 is communicably connected to a management server via a network (not illustrated). The management server is installed in a casino, an amusement facility, or the like. In the management server, a command or a signal corresponding to an operation by a store clerk or the like is supplied to the CPU 110 via the communication interface 180.

### <<<Types of Symbols>>>

The CPU 110 of the gaming machine 10 displays symbols on the lower display 210. In the present embodiment, there are 26 types of symbols, specifically, which are wild, a golden lion, a golden gorilla, a golden ostrich, a golden elephant, a large lion, a large gorilla, a large ostrich, a large elephant, a small lion, a small gorilla, a small ostrich, a small elephant, a mongoose, A, K, Q, J, 10, BONUS, CHANGE, RESPIN, BLANK 1, BLANK 2, BLANK 3, and BLANK 4 (not illustrated).

Note that, in the following, for convenience, W1 is shown as wild, G1 as the golden lion, G2 as the golden gorilla, G3 as the golden ostrich, G4 as the golden elephant, S1 as the large lion, S2 as the large gorilla, S3 as the large ostrich, S4 as the large elephant, M1 as the small lion, M2 as the small gorilla, M3 as the small ostrich, M4 as the small elephant, M5 as the mongoose, L1 as A, L2 as K, L3 as Q, L4 as J, L5 as 10, B1 as BONUS, T1 as CHANGE, T2 as RESPIN, BK1 as BLANK1, BK2 as BLANK2, BK3 as BLANK3, and BK4 as BLANK4.

Here, W1 is a wild symbol. B1, T1, and T2 are scatter symbols. In addition, the golden lion (G1), the golden gorilla (G2), the golden ostrich (G3), and the golden elephant (G4) are referred to as special color specific symbols.

<<<Symbol Display Area 400, Video Reels 410a to 410e>>>

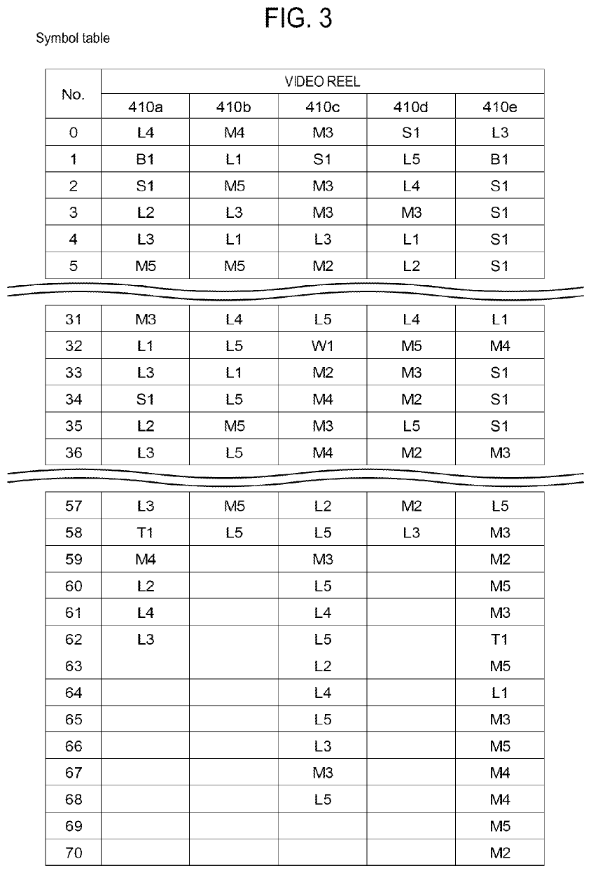

As illustrated in FIG. 1, the lower display 210 has the symbol display area 400. In the symbol display area 400, the five video reels 410a, 410b, 410c, 410d, and 410e are displayed. Note that, in a case where it is not particularly necessary to distinguish, or in a case where it is not possible to distinguish, it is simply referred to as the video reel 410. To the video reels 410a to 410e each, a plurality of symbols determined in advance are assigned in a predetermined order (see FIG. 3). FIG. 3 is a table showing an example of a symbol table. Note that the symbol table shown in FIG. 3 is used in the base game to be described later. As will be described later, symbols assigned to the video reels 410a to 410e are switched depending on a type of the game.

The video reels 410a to 410e are scrolled and stopped in the symbol display area 400. In other words, the symbols are displayed to be moved or stop-displayed in the symbol display area 400.

### <<<<Stop Position, Rearrangement of Symbols>>>

As illustrated in FIG. 1, in the present embodiment, the symbol display area 400 has stop positions (cells) of 4 rows and 5 columns (broken lines in FIG. 1). When the video reels 410a to 410e are stopped, symbols are stop-displayed at individual stop positions of 4 rows and 5 columns. That is, when the video reels 410a to 410e are stopped, a total of 20 symbols are displayed (rearranged) in a matrix of 4 rows and 5 columns. As will be described later, every time a unit game is played, a plurality of symbols are rearranged in the symbol display area 400, and the symbols corresponding to a lottery result in the unit game is displayed.

### <<<Pay Line 420>>>

The gaming machine 10 has the pay line 420 in the symbol display area 400. In the present embodiment, the number of the pay lines 420 is 1024 (=4⁵). In FIG. 1, only representative pay lines 420 are shown. In the present embodiment, regardless of an operation of the BET button 320, all the 1024 pay lines 420 are enabled.

The pay line 420 is formed by connecting one stop position selected for each of the video reels 410a to 410e. Establishment of the winning combination is determined by a type and the number of symbols continuously aligned along the pay line 420 from a leftmost stop position. Note that, in the present embodiment, the determination target of the winning combination is an alignment of symbols continuously from the leftmost stop position along the pay line 420.

### <<<Winning Combination and Payout (Normal Payout)>>>

FIG. 4 is a payout table showing a correspondence relationship between a winning combination and a payout (hereinafter referred to as a normal payout). Note that the number of normal payouts shown in FIG. 4 is a credit value, and is a value associated with a predetermined amount of money. The correspondence relationship of the payout table shown in FIG. 4 is stored in advance in the storage device 140.

In No. 2 to No. 15 illustrated in FIG. 4, the normal payout is associated with a winning combination. In a case where symbol lottery processing is executed, and the type and number of symbols continuously aligned from the leftmost stop position along the pay line 420 match one of the winning combinations No. 2 to No. 15, the winning combination is established, and a normal payout corresponding to the winning combination is discharged (stored in the RAM 130). The gaming machine 10 according to the present embodiment includes not only a normal payout but also a special rate and a JACKPOT payout, and the special rate and the JACKPOT payout will be described later.

For example, the normal payout when two pieces of G1 or S1 (No. 2) are aligned along the pay line 420 is 50. The normal payout when five pieces of G1 or S1 (No. 2) are aligned along the pay line 420 is 200.

In No. 19 to No. 22, the winning combination is not defined, and there is no normal payout. No. 1 is a wild symbol, and there is no normal payout. No. 16 to No. 18 are scatter symbols and are used as a shift condition to different types of games, and there is no normal payout in the present embodiment. For example, the scatter symbols are used as a shift condition from a normal game (the base game, high probability game 1, high probability game 2, high probability game 3, and high probability game 4) to be described later to the free game (free game A, free game B, and free game C). Further, the scatter symbols may be used as a shift condition at a time of shifting between the base game, high probability game 1, high probability game 2, high probability game 3, and high probability game 4, and shifting between free game A, free game B, and free game C.

Note that, when the player finishes the game of the gaming machine 10, the ticket discharging device 270 prints the number of credits owned by the player, on the ticket. In this way, it is possible to perform cash-out in the gaming machine 10.

### <<<Game Type and Transition>>>

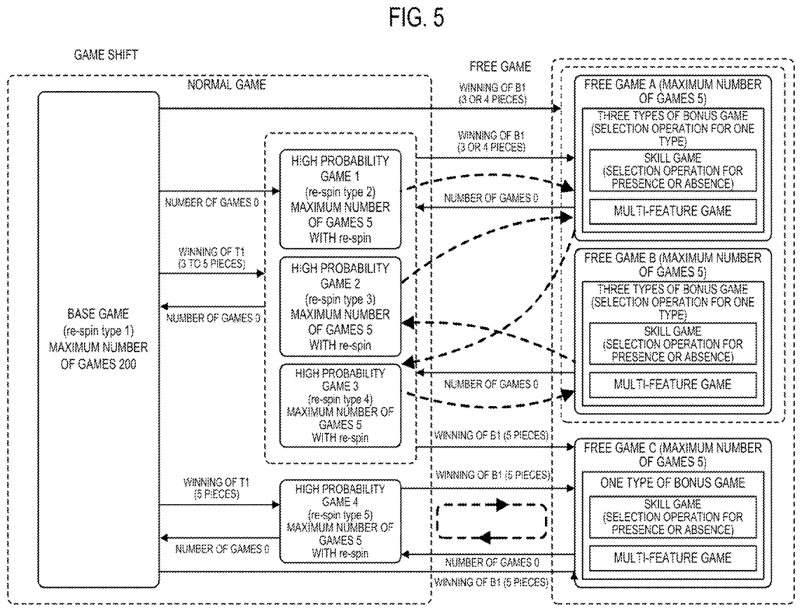

FIG. 5 is a diagram illustrating a transition of a game to be executed in the gaming machine 10.

### <<Normal Game and Free Game>>

The gaming machine 10 has a normal game and a free game. When a winning combination having a normal payout is established in the normal game or the free game, a normal payout corresponding to the winning combination is discharged.

When a winning combination of bonus symbol B1 is established in the symbol lottery processing in the normal game, a shift is made to the free game in accordance with the number of bonus symbols B1. In the free game, a winning combination having a normal payout is easily established, and a normal payout more than that in the normal game is easily obtained. As described above, the free game is an advantageous game in which the winning combination is more easily established than the normal game.

### <Base Game, High Probability Game 1, High Probability Game 2, and High Probability Game 3>

The normal game includes five types of games of: a base game, high probability game 1, high probability game 2, high probability game 3, and high probability game 4. High probability game 1, high probability game 2, high probability game 3, and high probability game 4 have mutually different symbol tables. When a shift is made to high probability game 1, high probability game 2, high probability game 3, and high probability game 4, the corresponding symbol table is selected. In high probability game 1, high probability game 2, high probability game 3, and high probability game 4, a probability of shifting to the free game is higher than that in the base game, and it is easy to shift to the free game. Therefore, high probability game 1, high probability game 2, high probability game 3, and high probability game 4 are games that are more advantageous than the base game.

When the winning combination of the CHANGE symbol T1 or the RESPIN symbol T2 is established in the symbol lottery processing in the base game, a shift is made to high probability game 1, high probability game 2, high probability game 3, and high probability game 4 in accordance with the number of CHANGE symbols T1 and the number of RESPIN symbols T2. An end condition of high probability game 1, high probability game 2, high probability game 3, and high probability game 4 is to perform the unit game for a predetermined number of times, for example, up to five times, and the game returns to the base game when the unit game ends.

### <Re-Scrolling (Re-Spinning)>

Further, in the base game, high probability game 1, high probability game 2, high probability game 3, and high probability game 4, the video reel 410 is re-scrolled (re-spun) in the same unit game in accordance with the number of the bonus symbols B1 and the number of the CHANGE symbols T1 and the RESPIN symbols T2, which are determined in the symbol lottery processing. The video reel 410 in which the bonus symbol B1 is stop-displayed is not re-scrolled, and only the video reel 410 in which the bonus symbol B1 is not stop-displayed is re-scrolled. At the time of re-scrolling, the symbol lottery processing is executed again. When the bonus symbol B1 is stop-displayed, the number of bonus symbols B1 to be stop-displayed in the symbol display area 400 can be additionally increased. In this way, it is possible to increase the possibility of establishment of the winning combination of the bonus symbol B1, and to make it easy to shift to the free game.

### <Type of Re-Spinning (Re-Spinning A, Re-Spinning B, and Re-Spinning C)>

The gaming machine 10 includes three types of re-spinning, which are re-spinning A, re-spinning B, and re-spinning C. Re-spinning A, re-spinning B, and re-spinning C have mutually different symbol tables. Re-spinning A, re-spinning B, and re-spinning C are selected when a condition such as stop-display of the bonus symbol B1 is established, and the corresponding symbol table is selected.

Re-spinning A is normal re-spinning. When re-spinning A is selected, it is possible to perform re-spinning up to three times in the unit game. When re-spinning B is selected, after four bonus symbols B1 are stop-displayed, re-spinning is performed only once in the unit game. When re-spinning C is selected, after three or four bonus symbols B1 are stop-displayed in high probability game 4, re-spinning is performed only once in the unit game. As a result, five bonus symbols B1 are stop-displayed, and the winning combination of the bonus symbol B1 is always established.

When execution of re-spinning is determined, the number of times of re-spinning is determined. When re-spinning is performed three times, the symbol table is switched to a symbol table in which the winning combination of three or more bonus symbols B1 is established by at least the third re-spinning. After a winning combination of three or four bonus symbols B1 is established in high probability game 4, the symbol table is switched to a symbol table in which a winning combination of five bonus symbols B1 is established. After the winning combination of four bonus symbols B1 is established in other than high probability game 4, the symbol table is switched to a symbol table that increases expectation of establishment of the winning combination of five bonus symbols B1. When the winning combination of three bonus symbols B1 is established in other than high probability game 4, re-spinning ends.

### <Free Game A, Free Game B, and Free Game C>

The free game includes three types of games of free game A, free game B, and free game C. In the free game, a winning combination having a normal payout is likely to be established, and the normal payout can be obtained more than in the normal game.

The contents of free game A and free game B are the same. Free game A and free game B have different return destinations in the normal game. The return destination will be described later. Free game A and free game B have three types of bonus games: a lion bonus game, a gorilla bonus game, and an ostrich bonus game. The Lion bonus game, the gorilla bonus game, and the ostrich bonus game may be selected by a player's operation.

Free game C has an elephant bonus game. The elephant bonus game cannot be selected by a player's operation.

An end condition of the lion bonus game, the gorilla bonus game, the ostrich bonus game, and the elephant bonus game is to perform the unit game for a predetermined number of times, for example, up to five times, and the game returns to any one of high probability game 2, high probability game 3, and high probability game 4 after the end.

### <Shift Continuity 1>

When the winning combination of three or four bonus symbols B1 is established in the base game, high probability game 1, or high probability game 2, a shift is made from the base game or high probability game 1 to free game A. When the unit game is played up to a predetermined number of times in free game A, free game A is ended, and a shift is made to high probability game 3. In high probability game 3, when the winning combination of three or four bonus symbols B1 is established again, a shift is made from high probability game 3 to free game B. When the unit game is played up to a predetermined number of times in free game B, free game B is ended, and a shift is made to high probability game 2. In high probability game 2, when the winning combination of three or four bonus symbols B1 is established, a shift can be made to free game A.

### <Shift Continuity 2>

When the winning combination of five bonus symbols B1 is established in the base game or high probability game 4, a shift is made from the base game or high probability game 4 to free game C. When the unit game is played up to a predetermined number of times in free game C, free game C is ended, and a shift is made again to high probability game 4. In high probability game 4, when the winning combination of five bonus symbols B1 is established again, a shift can be made to free game C.

### <Multi-Feature Game>

Free game A, free game B, and free game C have a multi-feature game. The multi-feature game is executed when the player wins in lottery processing. When the multi-feature game is won, a special rate and an additional rate by which the normal payout is multiplied, the JACKPOT payout, and the like are determined by the lottery processing. Moreover, an amount of discharge can be increased. The special rate, the additional rate, and the JACKPOT payout will be described later.

### <Skill Game>

Free game A, free game B, and free game C have a skill game. The skill game may be selected by a player's operation. The skill game is executed when specific symbols are in a predetermined alignment along the pay line. The specific symbols will be described later.

In the skill game, the video reel 410 in which the bonus symbol B1 is stop-displayed is not scrolled, and the video reel 410 in which the symbol B1 is not stop-displayed is re-scrolled. In a case where the symbol lottery processing is executed again at a time of re-scrolling and the specific symbol can be stop-displayed along the pay line, the number of specific symbols to be stop-displayed in the symbol display area 400 can be additionally increased. In this way, the possibility of establishment of the winning combination of the specific symbol is enhanced.

### <Specific Symbol>

The specific symbol is a symbol associated with a type of the bonus game. Specifically, the specific symbol is associated as follows. W1, G1, and S1 are associated with the lion bonus game (without a skill game). W1, G2, and S2 are associated with the gorilla bonus game (without a skill game). W1, G3, and S3 are associated with the ostrich bonus game (without a skill game). W1, G4, and S4 are associated with the elephant bonus game (without a skill game). W1, G1, and S1 are associated with the lion bonus game (with a skill game). W1, G2, and S2 are associated with the gorilla bonus game (with a skill game). W1, G3, and S3 are associated with the ostrich bonus game (with a skill game). W1, G4, and S4 are associated with the elephant bonus game (with a skill game).

Hereinafter, processing of the gaming machine 10 will be described with reference to FIGS. 6, 7, 9, 10, 12, 16 to 20, 22, and 27 to 28. Note that it is assumed that the gaming machine 10 has completed startup processing such as initialization, and is operating normally. In addition, it is assumed that the card reading device 250, the bill inserting device 260, and the like are operated by the player and necessary credits are inputted.

### <<<Normal Game Processing>>>

FIG. 6 is a flowchart illustrating normal game processing called and executed in the normal game.

First, when the gaming machine 10 is powered on, the CPU 110 of the controller 100 reads a BIOS from the ROM 120 and executes the BIOS, and then reads a game program from the storage device 140, and develops and stores the game program in an executable manner in the RAM 130 (step S611).

Next, the CPU 110 of the controller 100 executes initialization processing at a time of an end of the unit game (step S613). For example, the number of BETs, symbols determined by the lottery processing, and the like are initialized. In addition, the number of games is subtracted. When re-spinning described later is performed, the number of games is not subtracted, and the number of times of re-spinning is subtracted.

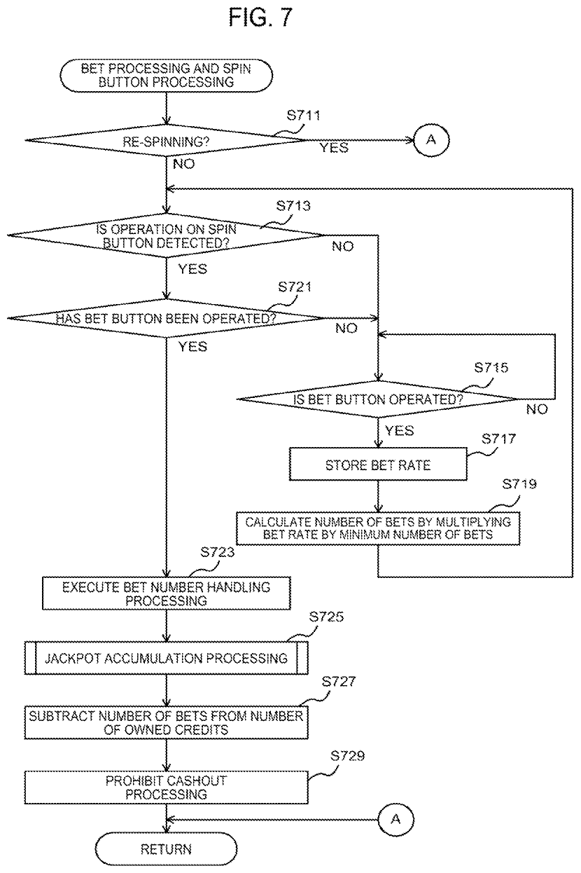

Next, the CPU 110 of the controller 100 reads and executes the BET processing and the SPIN button processing illustrated in FIG. 7 (step S615). In this processing, it is determined whether or not the BET button 320 and the SPIN button 330 has been operated by the player, and processing on the number of credits owned by the player is executed.

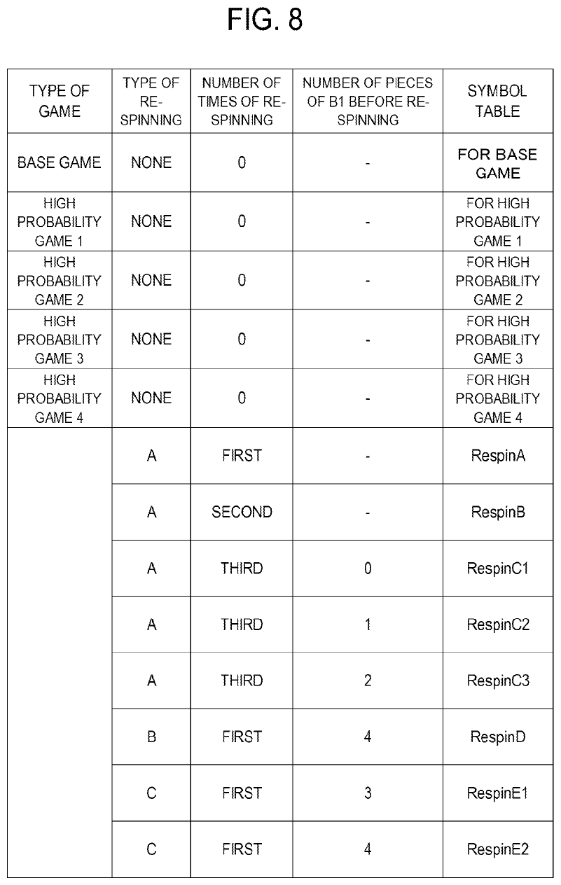

Next, the CPU 110 of the controller 100 selects a symbol table (step S617). In this processing, the symbol table is selected in accordance with conditions of a symbol table selection table shown in FIG. 8.

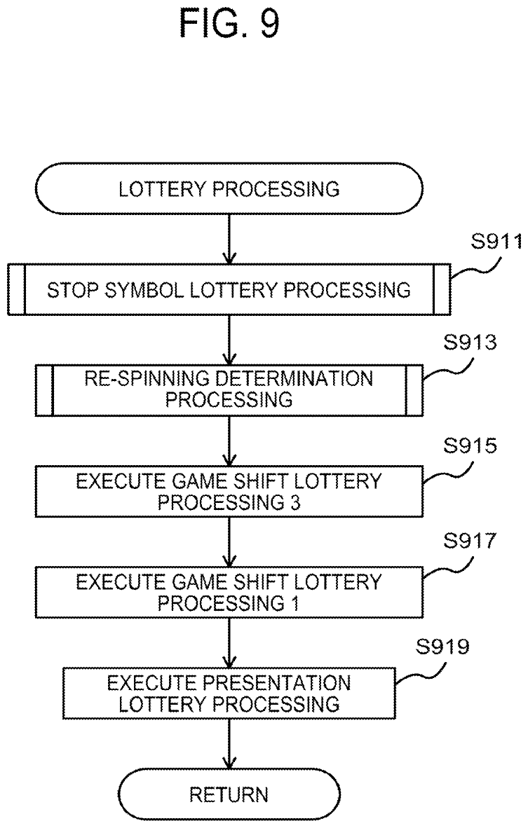

Next, the CPU 110 of the controller 100 calls and executes lottery processing illustrated in FIG. 9 (step S619). This lottery processing includes stop symbol lottery processing, re-spinning determination processing, game shift lottery processing 3, game shift lottery processing 1, and presentation lottery processing. The stop symbol lottery processing determines a symbol to be stop-displayed at a predetermined position, for example, at the bottom, in the symbol display area 400. Details of the lottery processing will be described in detail later.

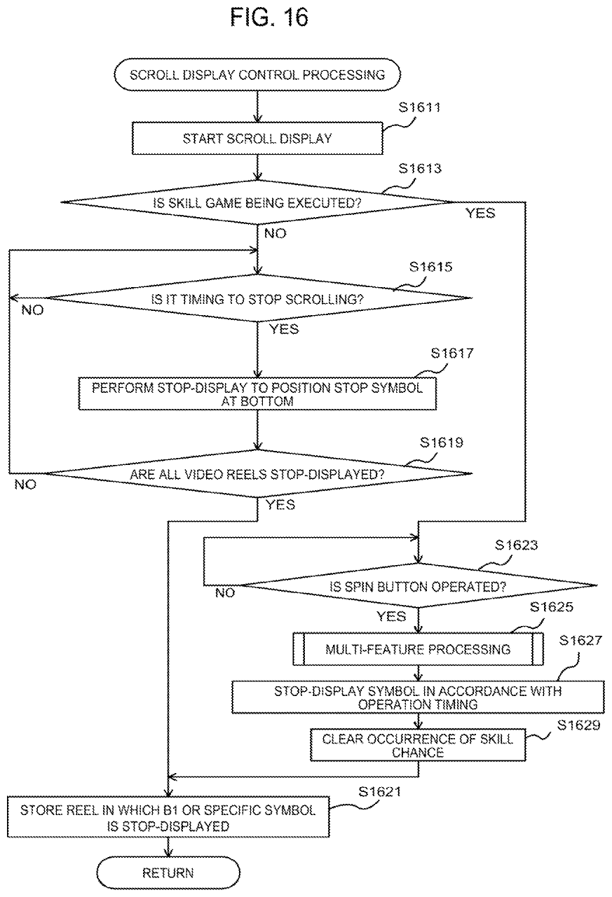

Next, the CPU 110 of the controller 100 calls and executes scroll display control processing illustrated in FIG. 16 (step S621). With this processing, the five video reels 410a to 410e are scrolled and then stopped in the symbol display area 400 of the lower display 210. In this way, a total of 20 symbols are rearranged in the matrix of 4 rows and 5 columns. Details of the scroll display control processing will be described in detail later.

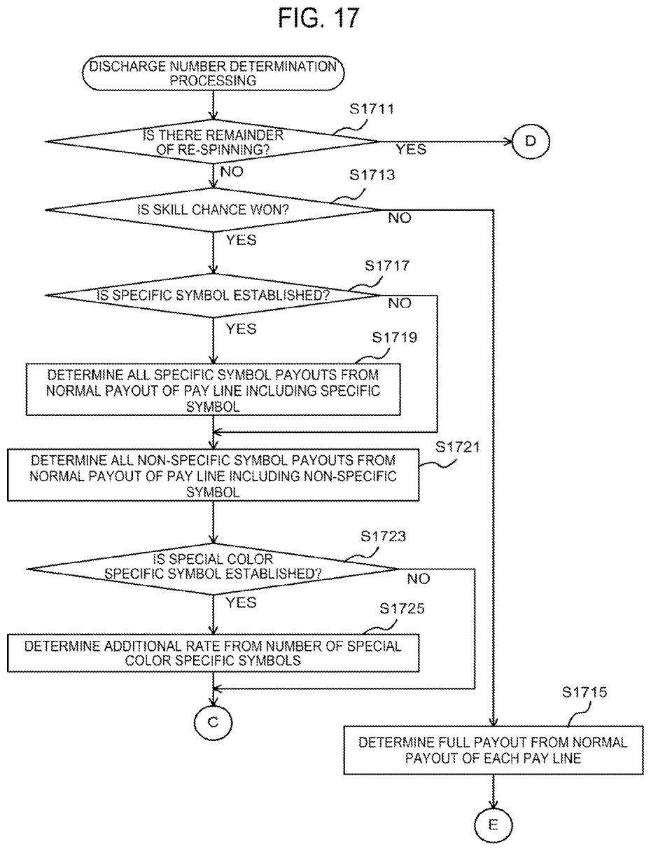

Next, the CPU 110 of the controller 100 calls and executes discharge number determination processing illustrated in FIG. 17 (step S623). It is determined whether or not a winning combination is established, and a total payout to be discharged is determined by obtaining a sum of payouts for which the winning combination is established. Details of the discharge number determination processing will be described in detail later.

Next, the CPU 110 of the controller 100 permits cash-out processing (step S624). The player can print owned credits by the ticket discharging device 270, and end the play in the gaming machine 10.

Next, the CPU 110 of the controller 100 determines whether or not a free game shift condition is established (step S625). The free game shift condition is establishment of a winning combination of the bonus symbol B1. Specifically, when three to five bonus symbols B1 are stop-displayed in the symbol display area 400, the free game shift condition is established.

When the CPU 110 of the controller 100 determines that the free game shift condition is not established in the determination processing of step S625 (NO), the CPU 110 determines whether or not there is a shift in the normal game (step S627). A shift to any one of the base game and high probability games 1 to 4 is determined by game shift lottery processing 1, game shift lottery processing 3, or the like to be described later.

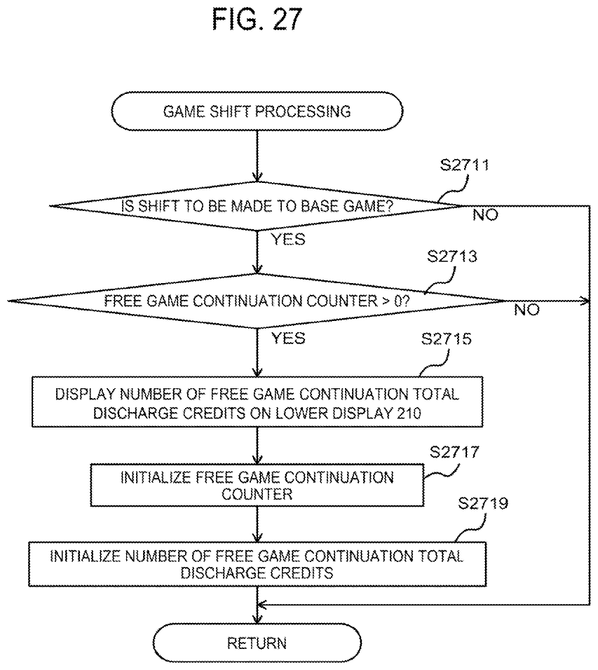

Next, when the CPU 110 of the controller 100 determines that there is no shift in the normal game in the determination processing of step S627 (NO), the process immediately returns to step S613. This causes a new unit game to be started while maintaining the same game of the normal game.

Whereas, when the CPU 110 of the controller 100 determines that there is a shift in the normal game in the determination processing of step S627 (YES), the CPU 110 executes game shift processing illustrated in FIG. 27 (step S628), sets the number of games of the shift destination game (step S629), causes a shift to a shift destination game (step S631), and returns the process to step S613. As a result, a new unit game in the shift destination game in the normal game is started.

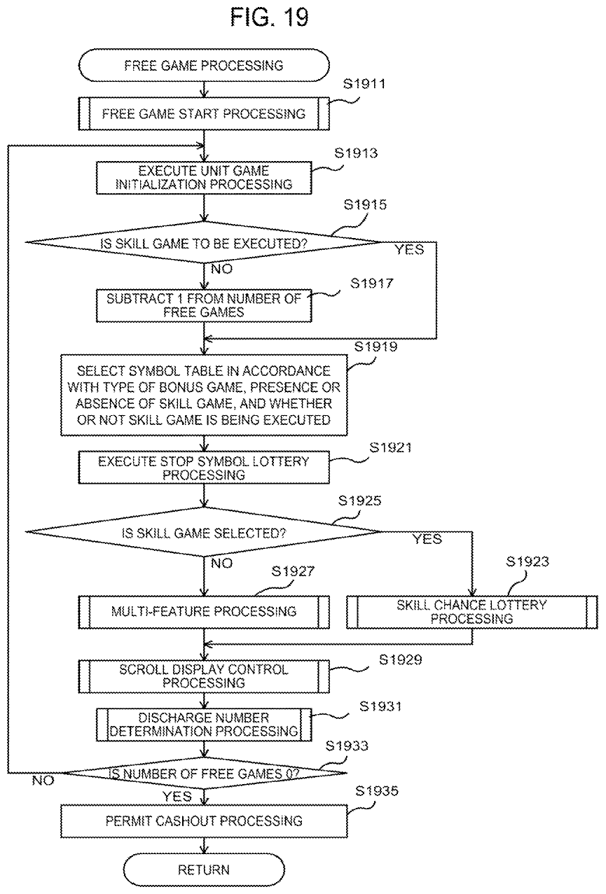

When the CPU 110 of the controller 100 determines that the free game shift condition is established in the determination processing of step S625 (YES), free game processing of FIG. 19 is called and executed (step S633).

Next, the CPU 110 of the controller 100 executes game shift lottery processing 2 (step S635), executes the processes of steps S629 and S631, and returns the process to step S613. As a result, the game returns from the free game to any one of the base game and high probability games 1 to 4, and a new unit game is started.

Game shift lottery processing 2 is processing of, at a time of returning from the free game to the normal game, determining whether to return to any one of the base game and high probability games 1 to 4 in the normal game, by lottery processing. The lottery processing is executed in accordance with types of free games A, B, and C, to determine winning or non-winning of the base game and high probability games 1 to 4.

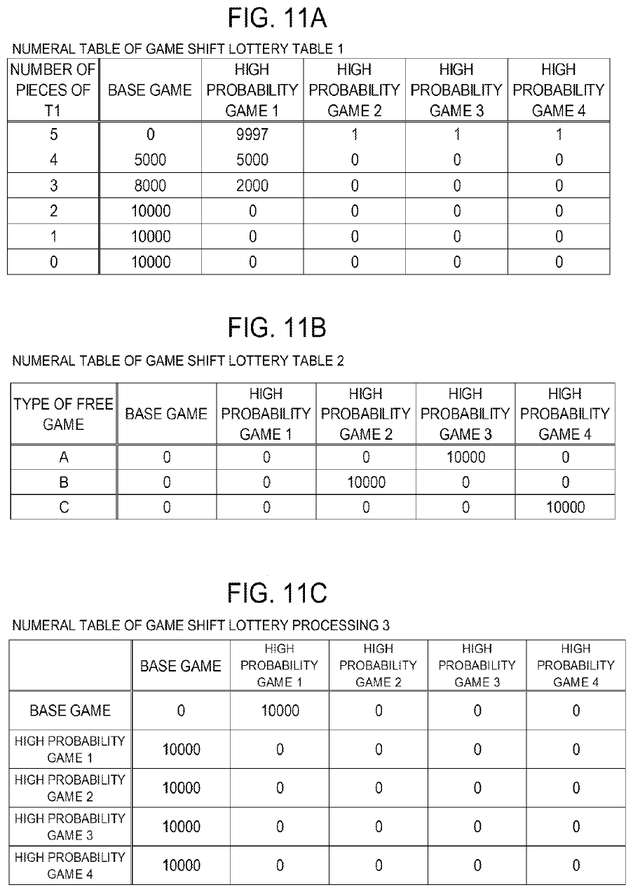

FIG. 11B is a numeral table of game shift lottery processing 2, and illustrates a likelihood of winning or non-winning of the base game and high probability games 1 to 4. Note that the numeral is a ratio obtained by comparing numerical ranges such as a numerical range corresponding to winning and a numerical range corresponding to non-winning, which are defined for extracting a random number value, to determine winning or non-winning (missing). Note that, the lottery result is winning when the extracted random number value is included in the numerical range corresponding to winning, and the lottery result is non-winning when the extracted random number value is included in the numerical range corresponding to non-winning. In the example illustrated in FIG. 11B, the numeral is set such that free game A uniquely returns to high probability game 3, free game B uniquely returns to high probability game 2, and free game C uniquely returns to high probability game 4. Note that the number of values shown in game shift lottery table 2 can be appropriately determined, and the game can be variously returned from the free game to any one of the base game and high probability games 1 to 4.

### <<<Symbol Table Selection Table in Normal Game>>>

FIG. 8 is a symbol table selection table for selecting a symbol table in the normal game. The symbol table selection table is used in the process of step S617 of the normal game processing of FIG. 6.

First, when none of re-spinning A to re-spinning C is selected, the CPU 110 of the controller 100 selects a symbol table for the base game in a case of the base game, selects a symbol table for high probability game 1 in a case of high probability game 1, selects a symbol table for high probability game 2 in a case of high probability game 2, and selects a symbol table for high probability game 3 in a case of high probability game 3.

Further, when re-spinning A is selected, re-spinning is the first time, and the bonus symbol B1 is not stop-displayed at the time before the re-spinning, the CPU 110 of the controller 100 selects a symbol table of Respin A. When re-spinning A is selected, re-spinning is the second time, and the bonus symbol B1 is not stop-displayed at the time before the re-spinning, the CPU 110 of the controller 100 selects a symbol table of Respin B.

Moreover, when re-spinning A is selected, re-spinning is the third time, and the bonus symbol B1 is not stop-displayed at the time before the re-spinning, the CPU 110 of the controller 100 selects a symbol table of Respin C1. When re-spinning A is selected, re-spinning is the third time, and one bonus symbol B1 is stop-displayed at the time before the re-spinning, the CPU 110 of the controller 100 selects a symbol table of Respin C2. When re-spinning A is selected, re-spinning is the third time, and two bonus symbol B1 are stop-displayed at the time before the re-spinning, the CPU 110 of the controller 100 selects a symbol table of Respin C3.

Furthermore, when re-spinning B is selected, re-spinning is the first time, and four bonus symbol B1 are stop-displayed at the time before the re-spinning, the CPU 110 of the controller 100 selects a symbol table of Respin D.

Moreover, when re-spinning C is selected, re-spinning is the first time, and three bonus symbol B1 are stop-displayed at the time before the re-spinning, the CPU 110 of the controller 100 selects a symbol table of Respin E1. When re-spinning C is selected, re-spinning is the first time, and four bonus symbol B1 are stop-displayed at the time before the re-spinning, the CPU 110 of the controller 100 selects a symbol table of Respin E2.

### <<<BET Processing and SPIN Button Processing>>>

FIG. 7 is a flowchart illustrating the BET processing and the SPIN button processing. This processing is called and executed in step S615 of the normal game processing of FIG. 6.

First, the CPU 110 of the controller 100 determines whether or not to perform re-spinning (step S711).

In a case where the CPU 110 of the controller 100 determines to perform re-spinning in the determination processing of step S711 (YES), this subroutine is immediately ended.

In a case of re-spinning, it is not necessary to operate the BET button 320 or the SPIN button 330, and the process immediately returns to the normal game processing of FIG. 6 to execute the symbol table selection processing of step S617.

When the CPU 110 of the controller 100 determines not to perform re-spinning in the determination processing of step S711 (NO), the CPU 110 determines whether or not the SPIN button 330 has been operated (step S713).

When the CPU 110 of the controller 100 determines that the SPIN button 330 has not been operated in the determination processing of step S713 (NO), the CPU 110 determines whether or not the BET button 320 has been operated (step S715).

When the CPU 110 of the controller 100 determines that the BET button 320 has not been operated in the determination processing of step S715 (NO), the process returns to step S715. Since the BET rate has not yet been determined and the game cannot be started, the process returns to step S715.

When the CPU 110 of the controller 100 determines that the BET button 320 has been operated in the determination processing of step S715 (YES), the CPU 110 stores a BET rate corresponding to the operated BET button 320 (step S717), determines the number of BETs by multiplying the BET rate by the minimum number of BETs (step S719), and returns the process to step S713. The minimum number of BETs can be 100 credits or the like. For example, when the player operates the “BET×2” button 320b, the BET rate is set to 2. In this case, the number of BETs is to be 200 by multiplying 100 by 2.

When the CPU 110 of the controller 100 determines that the SPIN button 330 has been operated in the determination processing of step S713 (YES), the CPU 110 determines whether or not the BET button 320 has already been operated (step S721).

When the CPU 110 of the controller 100 determines that the BET button 320 has not been operated yet in the determination processing of step S721 (NO), the process shifts to step S715.

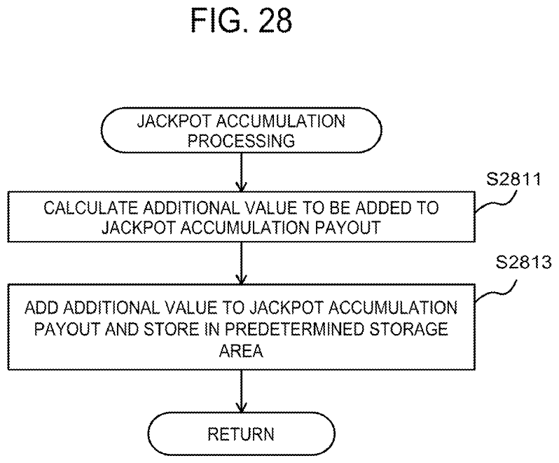

When the CPU 110 of the controller 100 determines that the BET button 320 has already been operated in the determination processing of step S721 (YES), jackpot accumulation processing illustrated in FIG. 28 is called and executed (step S725).

Next, the CPU 110 of the controller 100 subtracts the number of BETs from the number of owned credits of the player (step S727).

Next, the CPU 110 of the controller 100 prohibits the cash-out processing (step S729), and ends this subroutine.

By executing this subroutine, the unit game of the normal game can be started.

### <<<Lottery Processing>>>

FIG. 9 is a flowchart illustrating the lottery processing. This processing is called and executed in step S619 of the normal game processing of FIG. 6.

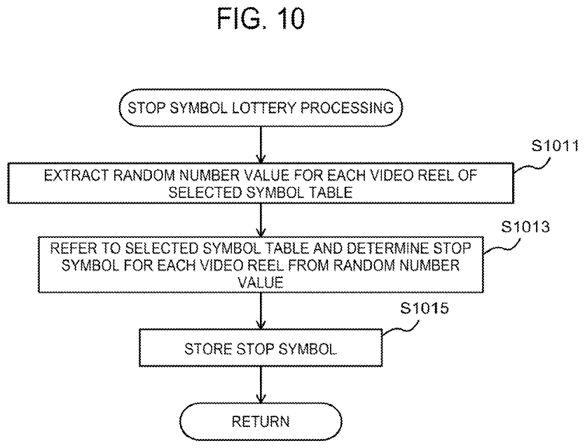

First, the CPU 110 of the controller 100 calls and executes the stop symbol lottery processing illustrated in FIG. 10 (step S911). Details of the stop symbol lottery processing will be described later.

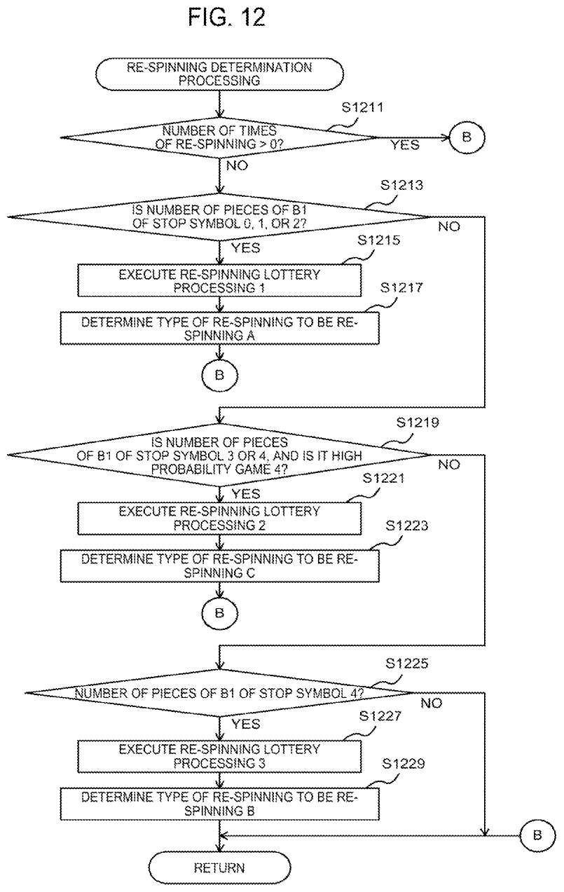

Next, the CPU 110 of the controller 100 calls and executes the re-spinning determination processing illustrated in FIG. 12 (step S913). Details of the re-spinning determination processing will be described later.

Next, the CPU 110 of the controller 100 executes game shift lottery processing 3 (step S915).

Game shift lottery processing 3 is processing for determining a next shift destination game when the number of games becomes 0 in each of the base game, high probability game 1, high probability game 2, high probability game 3, and high probability game 4 in the normal game. By executing game shift lottery processing 3, a shift can be made from any one of the base game, high probability game 1, high probability game 2, high probability game 3, and high probability game 4 in the normal game, to any one of the base game, high probability game 1, high probability game 2, high probability game 3, and high probability game 4 in the normal game. The lottery processing is executed in accordance with the base game, high probability game 1, high probability game 2, high probability game 3, and high probability game 4, to determine winning or non-winning of the base game and high probability games 1 to 4.

FIG. 11C is a numeral table of game shift lottery processing 3, and is a numeral table indicating a likelihood of winning or non-winning of the base game and high probability games 1 to 4. In the example illustrated in FIG. 11C, a shift is uniquely made to high probability game 1 when the base game ends, a shift is uniquely made to the base game when high probability game 1, high probability game 2, or high probability game 3 ends, and a shift is uniquely made to the base game when high probability game 4 ends. Note that the number of values shown in game shift lottery table 3 can be appropriately determined, and the game can be variously returned to any one of the base game and high probability games 1 to 4.

Next, the CPU 110 of the controller 100 executes game shift lottery processing 1 (step S917).

Game shift lottery processing 1 is processing for determining a next shift destination game in accordance with the number of CHANGE symbols T1 stop-displayed when the CHANGE symbol T1 is stop-displayed in the base game. By executing game shift lottery processing 1, a shift can be made from the base game to any one of the base game, high probability game 1, high probability game 2, high probability game 3, and high probability game 4. The lottery processing is executed in accordance with the number of CHANGE symbols T1, to determine winning or non-winning of the base game and high probability games 1 to 4.

FIG. 11A is a numeral table of game shift lottery processing 1, and illustrates a likelihood of winning or non-winning of the base game and high probability games 1 to 4. In the example illustrated in FIG. 11A, when the number of CHANGE symbols T1 is 5, a shift is made to any one of high probability game 1, high probability game 2, high probability game 3, and high probability game 4. When the number of CHANGE symbols T1 is 4 or 3, a shift is made to any one of the base game and high probability game 1. When the number of CHANGE symbols T1 is 0 to 2, the base game is maintained. Note that the number of values shown in game shift lottery table 1 illustrated in FIG. 11A can be appropriately determined, and various shifts can be made.

Next, the CPU 110 of the controller 100 executes the presentation lottery processing (step S919), and ends this subroutine. The presentation lottery processing is determined in accordance with a result of the stop symbol lottery processing of step S911. In accordance with a lottery result, presentation of enhancing and uplifting the feeling of expectation can be executed by the lower display 210, the upper display 220, the speaker 230, or the like.

### <<<Stop Symbol Lottery Processing>>>

FIG. 10 is a flowchart illustrating the stop symbol lottery processing. This processing is called and executed in step S911 of the lottery processing of FIG. 9.

First, the CPU 110 of the controller 100 extracts a random number value for each of the video reels 410a to 410e in accordance with the symbol table selected in the symbol table selection processing of step S617 of FIG. 6 (step S1011). The random number value is extracted from a range corresponding to the number of symbols defined in the symbol table.

Next, the CPU 110 of the controller 100 refers to the symbol table selected in the symbol table selection processing of step S617 of FIG. 6, and determines a stop symbol for each of the video reels 410a to 410e from the random number value (step S1013). Scrolling of the video reels 410a to 410e is stopped such that the symbol determined in this processing is stop-displayed at a predetermined position, for example, at the bottom, in the symbol display area 400. By determining the symbol to be stop-displayed at the bottom, symbols to be stop-displayed (symbols to be rearranged) at the individual stop positions of 4 rows and 5 columns in the symbol display area 400 can be determined.

Next, the CPU 110 of the controller 100 stores the symbol determined in the process of step S1013 in the RAM 130 of the controller 100 (step S1015), and ends this subroutine. By storing the symbol determined in the process of step S1013 in the RANI 130, the symbol can be used for control of stop-display of the symbol and for calculation of the payout.

Note that, at the time of re-spinning, the symbol lottery processing is executed with reference to a re-spinning symbol table, for only the video reel 410 to be re-spun among the video reels 410a to 410e.

### <<<Re-Spinning Determination Processing>>>

FIG. 12 is a flowchart illustrating the re-spinning determination processing. This processing is called and executed in step S913 of the lottery processing of FIG. 9.

First, the CPU 110 of the controller 100 determines whether or not a current number of times of re-spinning is larger than 0 (step S1211) That is, it is determined whether or not there is any remaining re-spinning.

When the CPU 110 of the controller 100 determines that the current number of times of re-spinning is larger than 0 in the determination processing of step S1211 (YES), this subroutine is immediately ended.

When the CPU 110 of the controller 100 determines that the current number of times of re-spinning is not larger than 0 in the determination processing of step S1211 (NO), that is, when re-pining is not determined, the CPU 110 determines whether or not the number of pieces of B1 (BONUS) stop-displayed is 0, 1, or 2 (step S1213).

When the CPU 110 of the controller 100 determines that the number of pieces of B1 (BONUS) stop-displayed is 0, 1, or 2 in the determination processing of step S1213 (YES), the CPU 110 executes re-spinning lottery processing 1 (step S1215), determines a type of re-spinning to be re-spinning A (step S1217), and ends this subroutine.

Re-spinning lottery processing 1 is executed in each of the base game, high probability game 1, high probability game 2, high probability game 3, and high probability game 4 in the normal game. In addition, in re-spinning lottery processing 1, in accordance with the number of pieces of B1 (BONUS) stop-displayed, and a sum of the number of pieces of T1 (CHANGE) stop-displayed and the number of pieces of T2 (RESPIN) stop-displayed, re-spinning lottery table 1 is referred to and a maximum number of times of re-spinning is determined from a random number value.

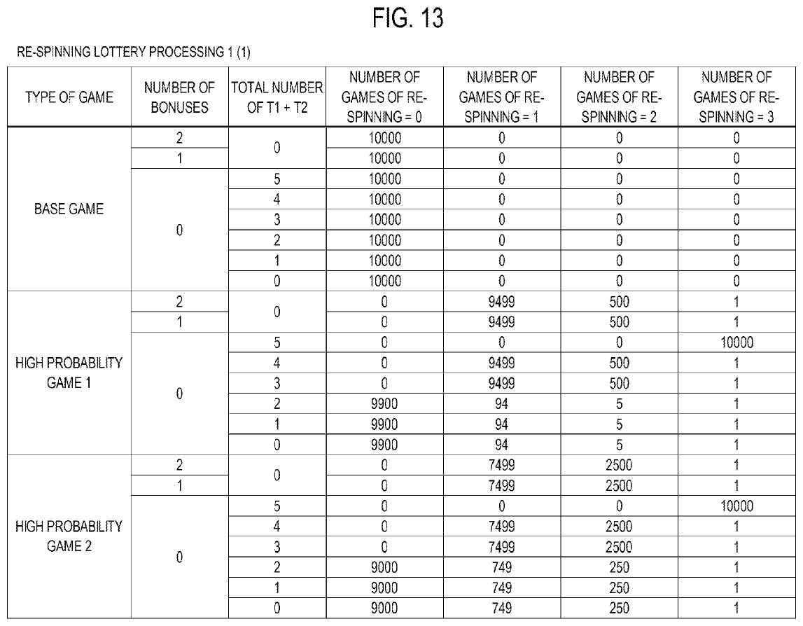

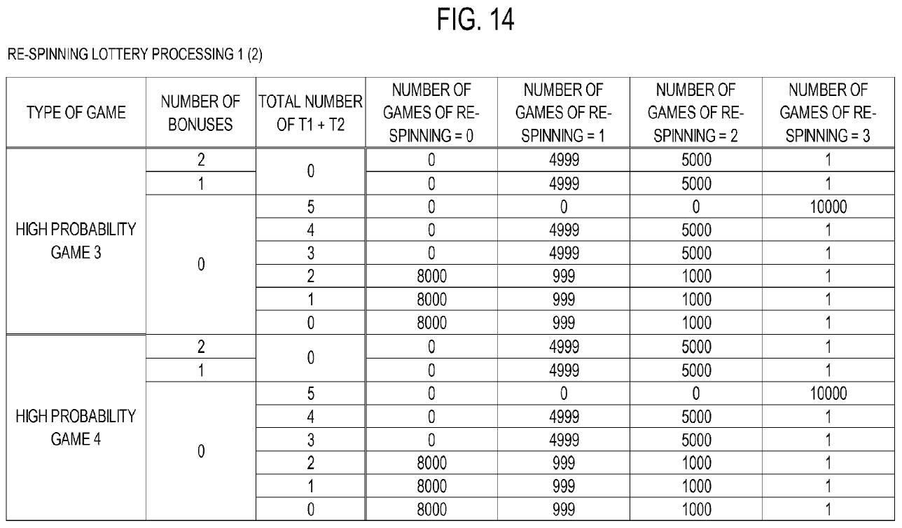

FIGS. 13 and 14 are numeral tables of re-spinning lottery processing 1, and illustrate a likelihood of winning or non-winning of a maximum number of times of re-spinning. For example, in the base game, the maximum number of times of re-spinning is determined to be 0 regardless of the number of pieces of B1 (BONUS) stop-displayed and the sum of the number of pieces of T1 (CHANGE) stop-displayed and the number of pieces of T2 (RESPIN) stop-displayed. In high probability game 1, when the number of pieces of B1 (BONUS) stop-displayed is 2 and the sum of the number of pieces of T1 (CHANGE) and the number of pieces of T2 (RESPIN) is 0, the maximum number of times of re-spinning is to be any one of 1, 2, and 3. In high probability game 1, when the number of pieces of B1 (BONUS) stop-displayed is 0 and the sum of the number of pieces of T1 (CHANGE) and the number of pieces of T2 (RESPIN) is 2, the maximum number of times of re-spinning is to be any one of 0, 1, 2, and 3. Note that, in a case where the number of pieces of B1 (BONUS) becomes 3 before re-spinning of the maximum number of times is executed, a shift is made to the free game, and thus the description is made as the “maximum number of times”.

When the CPU 110 of the controller 100 determines that the number of pieces of B1 (BONUS) stop-displayed is not 0, 1, or 2 in the determination processing of step S1213 (NO), the CPU 110 determines whether or not the number of pieces of B1 (BONUS) stop-displayed is 3 or 4 and whether or not the game is high probability game 4 (step S1219).

When the CPU 110 of the controller 100 determines that the number of pieces of B1 (BONUS) stop-displayed is 3 or 4 and the game is high probability game 4 in the determination processing of step S1219 (YES), the CPU 110 executes re-spinning lottery processing 2 (step S1221), determines a type of re-spinning to be re-spinning C (step S1223), and ends this subroutine.

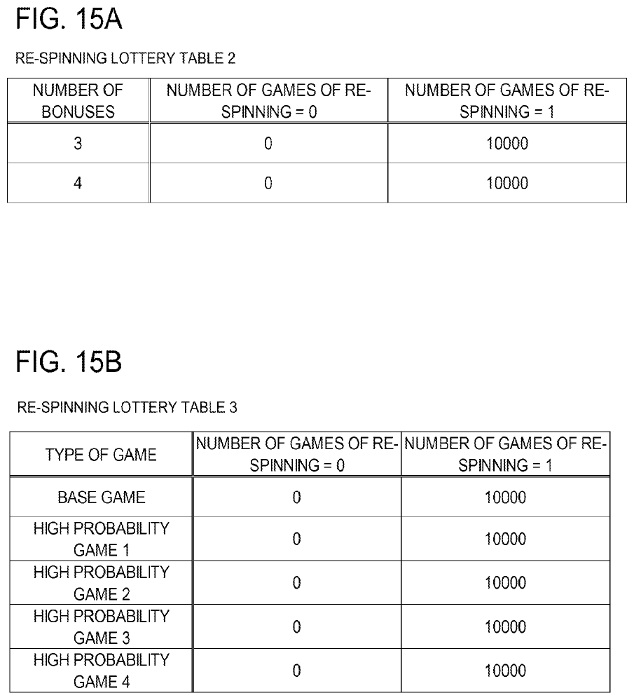

FIG. 15A is a numeral table of re-spinning lottery processing 2, and illustrates a likelihood of winning or non-winning of a maximum number of times of re-spinning. The maximum number of times of re-spinning is determined from a random number value in accordance with the number of pieces of B1 (BONUS) stop-displayed. In the example illustrated in FIG. 15A, when the number of pieces of B1 (BONUS) stop-displayed is 3 or 4, the maximum number of times of re-spinning is 1.

When the CPU 110 of the controller 100 determines that the number of pieces of B1 (BONUS) stop-displayed is not 3 or 4 or determines that the game is not high probability game 4 in the determination processing of step S1219 (NO), the CPU 110 determines whether or not the number of pieces of B1 (BONUS) stop-displayed is 4 (step S1225).

When the CPU 110 of the controller 100 determines that the number of pieces of B1 (BONUS) stop-displayed is 4 in the determination processing of step S1225 (YES), the CPU 110 executes re-spinning lottery processing 3 (step S1227), determines a type of re-spinning to be re-spinning B (step S1229), and ends this subroutine.

By performing the process of step S1229 to set re-spinning B (RespinD in FIG. 8), when four pieces of B1 (BONUS) are stop-displayed in other than high probability game 4, that is, in the base game, high probability game 1, high probability game 2, or high probability game 3, it is possible to increases expectation of establishment of the winning combination of five bonus symbols B1.

FIG. 15B is a numeral table of re-spinning lottery processing 3, and illustrates a likelihood of winning or non-winning of a maximum number of times of re-spinning. The maximum number of times of re-spinning is determined from a random number value in accordance with a type of the normal game. In the example illustrated in FIG. 15B, the maximum number of times of re-spinning is 1 in each of the base game and high probability games 1 to 4.

### <<<Scroll Display Control Processing>>>

FIG. 16 is a flowchart illustrating the scroll display control processing. This processing is called and executed in step S621 of the lottery processing of FIG. 6. The scroll display control processing in FIG. 16 is commonly executed in both the normal game and the free game. The processes of steps S1623 to S1629 in FIG. 16 are executed when a skill game of the free game described later is performed.

First, the CPU 110 of the controller 100 starts scrolling the five video reels 410a to 410e in the symbol display area 400 (step S1611).

Next, the CPU 110 of the controller 100 determines whether or not a skill game is being executed (step S1613).

When the CPU 110 of the controller 100 determines that the skill game is not being executed in the determination processing of step S1613 (NO), the CPU 110 determines whether or not it is a timing to stop scrolling of any one of the video reels 410a to 410e (step S1615).

When the CPU 110 of the controller 100 determines that it is not the timing to stop the scrolling in the determination processing of step S1615 (NO), the process returns to step S1615.

When the CPU 110 of the controller 100 determines that it is the timing to stop the scrolling in the determination processing of step S1615 (YES), the video reel 410 is stopped such that the symbol determined by the stop symbol lottery processing of FIG. 10 is displayed at the stop position at the bottom of the symbol display area 400 (step S1617)

Next, the CPU 110 of the controller 100 determines whether or not all the video reels 410a to 410e have been stopped (step S1619).

When the CPU 110 of the controller 100 determines that all the video reels 410a to 410e have not been stopped (NO), the process returns to step S1615.

When the CPU 110 of the controller 100 determines that all the video reels 410a to 410e have been stopped (YES), and when B1 (BONUS) or a specific symbol is stop-displayed, the CPU 110 stores the video reel 410 (step S1621), and ends this subroutine.

In the process of step S1621, the video reel 410 in which the bonus symbol B1 is stop-displayed is stored in the normal game. When the scroll display control processing of FIG. 16 is executed in the same unit game, only the video reel 410 in which the bonus symbol B1 has not been stop-displayed can be re-scrolled (re-spun), and the number of bonus symbols B1 to be stop-displayed in the symbol display area 400 can be additionally increased.

In addition, in the process of step S1621, the video reel 410 in which the specific symbol is stop-displayed is stored, in the free game. In a case where only a part of a specific one winning combination to be described later is established, when the scroll display control processing of FIG. 16 is executed in the same unit game, the specific one winning combination is made to be established by the skill game.

By the processes of steps S1611 to S1621 described above, the arrangement of 20 symbols is once released in the symbol display area 400 and then rearranged. By the rearrangement, 20 symbols are stop-displayed in the matrix of 4 rows and 5 columns.

When the CPU 110 of the controller 100 determines that the skill game is being executed in the determination processing of step S1613 (YES), the CPU 110 determines whether or not the SPIN button 330 has been operated (step S1623).

When the CPU 110 of the controller 100 determines that the SPIN button 330 has not been operated in the determination processing of step S1623 (NO), the process returns to step S1623.

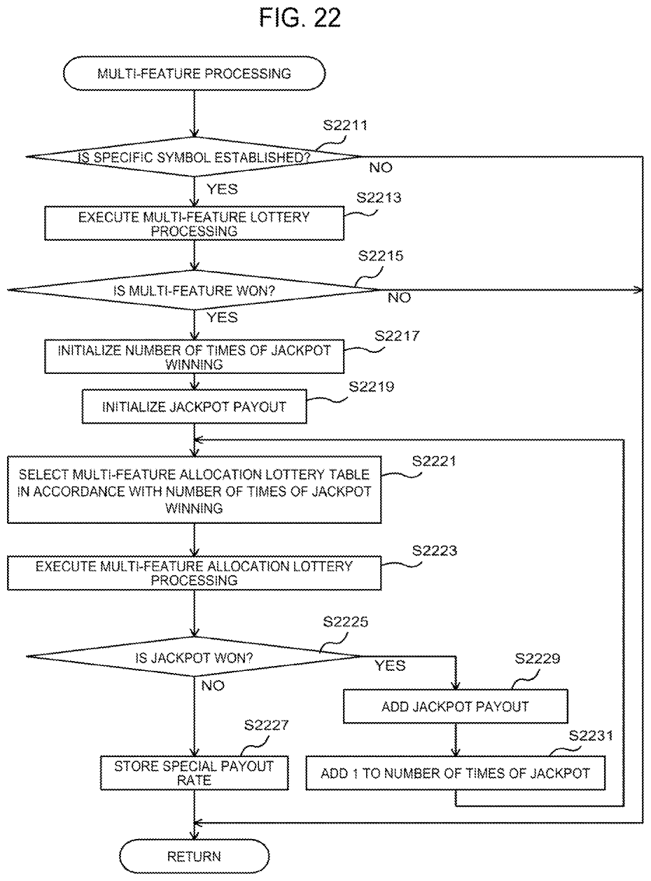

When the CPU 110 of the controller 100 determines that the SPIN button 330 has been operated in the determination processing of step S1623 (YES), multi-feature processing illustrated in FIG. 22 is called and executed (step S1625).

Next, the CPU 110 of the controller 100 stops scrolling of the video reel 410 according to the operated SPIN button 330 in accordance with a timing at which the SPIN button 330 has been operated, and stop-displays the symbol (step S1627)

Next, the CPU 110 of the controller 100 clears an occurrence of a skill chance (step S1629), and shifts the process to step S1621.

### <<<Discharge Number Determination Processing>>>

FIG. 17 is a flowchart illustrating the discharge number determination processing. This processing is called and executed in step S623 of the lottery processing of FIG. 6. The discharge number determination processing in FIG. 17 is commonly executed in both the normal game and the free game.

First, the CPU 110 of the controller 100 determines whether or not there is a remainder of re-spinning (step S1711).

When the CPU 110 of the controller 100 determines that there is a remainder of re-spinning in the determination processing of step S1711 (YES), that is, when the unit game is to be continued by further re-spinning, this subroutine is immediately ended.

When the CPU 110 of the controller 100 determines that there is no remainder of re-spinning in the determination processing of step S1711 (NO), that is, when the unit game is to be ended, the CPU 110 determines whether or not a skill chance has been won (step S1713).

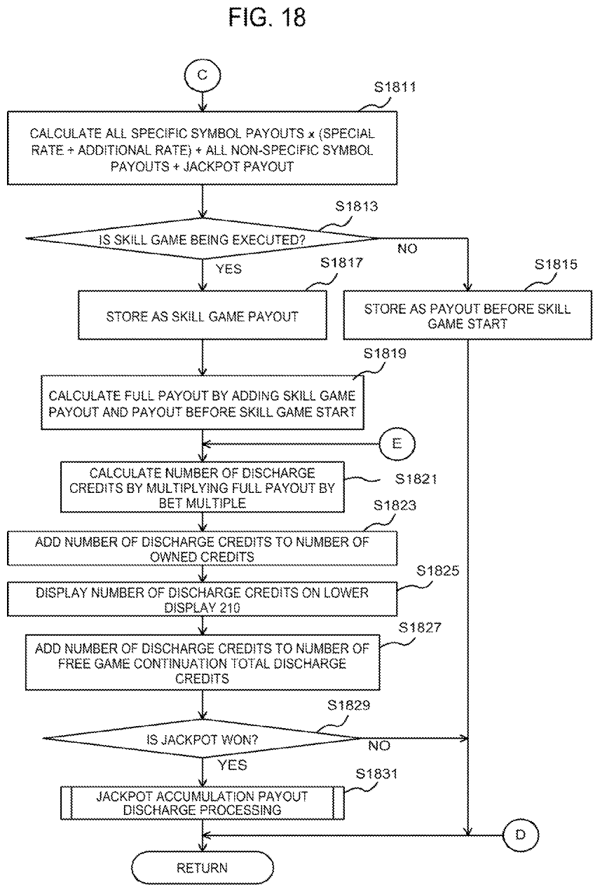

When the CPU 110 of the controller 100 determines that the skill chance has not been in the determination processing of step S1713 (NO), a full payout is determined by obtaining a sum of normal payouts from individual normal payouts of all the pay lines 420 in which a winning combination is established (step S1715). Thereafter, the process shifts to step S1821 in FIG. 18 to calculate the number of discharge credits, and the number of discharge credits is added to the number of owned credits in the process of step S1823.

When the CPU 110 of the controller 100 determines that the skill chance has been won in the determination processing of step S1713 (YES), the CPU 110 determines whether or not a winning combination of the specific symbol is established (step S1717).

When the CPU 110 of the controller 100 determines that the winning combination of the specific symbol is established in the determination processing of step S1717 (YES), the CPU 110 determines all the specific symbol payouts by obtaining a sum of normal payouts from individual normal payouts of all the pay lines 420 in which a winning combination of the specific symbol is established (step S1719).

When the CPU 110 of the controller 100 determines that the winning combination of the specific symbol has not been established in the determination processing of step S1717 (NO), or when the process of step S1719 is executed, the CPU 110 determines all the non-specific symbol payouts by obtaining a sum of normal payouts from individual normal payouts of all the pay lines 420 in which a winning combination of a non-specific symbol other than the specific symbol is established (step S1721).

Next, the CPU 110 of the controller 100 determines whether or not a special color specific symbol is included in the established winning combination of the specific symbol (step S1723). The special color specific symbol is a specific symbol decorated in a specific color, for example, gold, among the specific symbol, and is specifically G1, G2, G3, and G4.

When the CPU 110 of the controller 100 determines that the established winning combination of the specific symbol includes the special color specific symbol in the determination processing of step S1723 (YES), the CPU 110 determines an additional rate in accordance with a total number of special color specific symbols included in the established winning combination (step S1725).

Next, the CPU 110 of the controller 100 adds a value obtained by multiplying a value obtained by adding the special rate and the additional rate by all the specific symbol payouts, all the non-specific symbol payouts, and the JACKPOT payout (step S1811).

Next, the CPU 110 of the controller 100 determines whether or not a skill game is being executed (step S1813).

When the CPU 110 of the controller 100 determines that the skill game is not being executed in the determination processing of step S1813 (NO), that is, when the CPU 110 determines that the skill game has not started yet, the CPU 110 stores the value calculated in step S1811 in the RAM 130 as a payout before skill game start (step S1815), and ends this subroutine.

When the CPU 110 of the controller 100 determines that the skill game is being executed in the determination processing of step S1813 (YES), the CPU 110 stores the value calculated in step S1811 in the RAM 130 as a skill game payout (step S1817).

Next, the CPU 110 of the controller 100 adds the skill game payout stored in step S1817 and the payout before skill game start stored in step S1815 to calculate a full payout (step S1819).

Next, the CPU 110 of the controller 100 calculates the number of discharge credits by multiplying the full payout calculated in step S1819 by a BET rate (step S1821).

Next, the CPU 110 of the controller 100 adds the number of discharge credits to the number of owned credits (step S1823)

Next, the CPU 110 of the controller 100 displays the number of discharge credits on the lower display 210 (step S1825). All the number of discharge credits earned in the free game can be visually recognized by the player.

Next, the CPU 110 of the controller 100 adds the number of discharge credits to the number of free game continuation total discharge credits (step S1827). When the free game is continued, a total number of discharge credits earned in the continued free game can be visually recognized by the player.

Next, the CPU 110 of the controller 100 determines whether or not JACKPOT is won (step S1829).

When the CPU 110 of the controller 100 determines the JACKPOT is won in the determination processing of step S1829 (YES), the CPU 110 discharges a JACKPOT accumulation payout (step S1831) and ends this subroutine.

When the CPU 110 of the controller 100 determines that the JACKPOT is not won in the determination processing of step S1829 (NO), this subroutine is immediately ended.

### <<<First Shift Continuation and Second Shift Continuation>>>

As described above, the normal game is shifted to the free game, and the free game is shifted (returned) to the normal game. Furthermore, the normal game can be shifted to the free game. As described above, after shifting to the free game once, the gaming machine 10 can shift to the free game again, and has continuity of shifting to the free game. In particular, the gaming machine 10 has a first shift continuation and a second shift continuation that is different from the first shift continuation. The first shift continuation and the second shift continuation will be described.

### <<High Probability Game 2, High Probability Game 3, and High Probability Game 4>>

First, in the normal game, as shown in re-spinning lottery table 1 of FIG. 14, a maximum number of times of re-spinning is determined depending on the number of bonus symbols B1 stop-displayed in the symbol display area 400 and the total number of the CHANGE symbol T1 and the RESPIN symbol T2 (see step S913 in FIG. 9 and step S1215 in FIG. 12).

In re-spinning lottery table 1 illustrated in FIGS. 13 and 14, the numerals of high probability games 2 are determined such that the maximum number of times of re-spinning is relatively likely to be smaller than the numerals of high probability games 3 and 4. Whereas, the numerals of high probability games 3 and 4 are determined such that the maximum number of times of re-spinning is relatively likely to increase as compared with the numerals of high probability games 1 and 2. As described above, the maximum number of times of re-spinning tends to be larger in high probability games 3 and 4 than in high probability game 2. Note that the maximum number of times of re-spinning may be 3 also in high probability game 2, high probability game 3, and high probability game 4. In particular, when the total number of the CHANGE symbols T1 and the RESPIN symbols T2 is 5, the maximum number of times of re-spinning is always 3.

### <<Likelihood of Winning of Bonus Symbol B1 of Each Symbol Table>>

Further, in the normal game, as shown in FIG. 8, 13 types of symbol tables, which are for the base game, for high probability game 1, for high probability game 2, for high probability game 3, for high probability game 4, RespinA, RespinB, RespinC1, RespinC2, RespinC3, RespinD, RespinE1, and RespinE2, are determined in accordance with a type of the game. A likelihood of winning of the bonus symbol B1 in these symbol tables is defined as follows.

In the symbol tables for the base game, for high probability game 1, for high probability game 2, for high probability game 3, and for high probability game 4, the likelihood of winning of the bonus symbol B1 is almost the same. The symbol tables of RespinA and RespinB have a higher likelihood of winning of the bonus symbol B1 than the symbol tables for the base game, high probability game 1, high probability game 2, high probability game 3, and high probability game 4. The symbol tables of RespinC1, RespinC2, and RespinC3 have a higher likelihood of winning of the bonus symbol B1 than the symbol tables of RespinA and RespinB. The symbol tables of RespinE1 and RespinE2 have a higher likelihood of winning of the bonus symbol B1 than the symbol tables of RespinC1, RespinC2, and RespinC3.

Note that the symbol table of RespinD have a lower likelihood of winning of the bonus symbol B1 than the symbol tables for the base game, high probability game 1, high probability game 2, high probability game 3, and high probability game 4.

### <First Shift Continuation (Shift to Free Game A or Free Game B)>

As described above, when three or four bonus symbols B1 are stop-displayed in the symbol display area 400 in the base game, high probability game 1, and high probability game 2, a shift condition to the free game is satisfied, and a shift is made from the base game, high probability game 1, or the like, to free game A (see FIG. 5).

<Shift from Free Game A to High Probability Game 3>

When the unit game is played up to a predetermined number of times in free game A, an end condition of free game A is satisfied, and a shift is made from free game A to high probability game 3 (see FIG. 5). The shift from free game A to high probability game 3 is uniquely determined (see the numeral table of game shift lottery table 2 in FIG. 11B).

<Shift from High Probability Game 3 to Free Game B>

In high probability game 3, first, a symbol table for high probability game 3 is selected (see step S617 in FIG. 6, and FIG. 8). As described above, in high probability game 3, the maximum number of times of re-spinning tends to be larger than that in high probability game 2 (see FIG. 14). Moreover, a symbol table (RespinA) of re-spinning A is selected (see step S1217 in FIG. 12, and FIG. 8). Since the symbol table RespinA is used, the bonus symbol B1 is to be easily won.

Re-spinning is performed up to the maximum number of times of re-spinning. Every time re-spinning is performed, the symbol tables of RespinB, RespinC1, RespinC2, and RespinC3 are selected in accordance with the number of bonus symbols B1 stop-displayed in the symbol display area 400, and the bonus symbol B1 is to be more likely won. When three or four bonus symbols B1 are stop-displayed in the symbol display area 400, the shift condition to free game B is established. When the shift condition to free game B is established, a shift is made from high probability game 3 to free game B. Note that the shift from high probability game 3 to free game B is uniquely determined.

In this way, in a case where the first free game is free game A, the shift can be made to free game B via high probability game 3 after free game A ends, and two times of the free game can be easily continued. In this way, the first shift continuation is realized.

<Shift from Free Game B to High Probability Game 2>

When the unit game is played up to a predetermined number of times in free game B, a shift condition is satisfied, and a shift is made from free game B to high probability game 2. The shift from free game B to high probability game 2 is uniquely determined (see the numeral table of game shift lottery table 2 in FIG. 11B).

<Shift from High Probability Game 2 to Free Game A>

In high probability game 2, a symbol table for high probability game 2 is selected (see step S617 in FIG. 6, and FIG. 8). As described above, in high probability game 2, the maximum number of times of re-spinning tends to be smaller than that in high probability game 3 (see FIG. 14), and re-spinning is less likely to occur. Note that, in high probability game 2 as well, since the symbol table (RespinA) of re-spinning A is selected (see step S1217 in FIG. 12, and FIG. 8), the bonus symbol B1 is to be easily won.

However, as described above, since re-spinning is less likely to occur, the number of games reaches a predetermined number of times before the three or four bonus symbols B1 are stop-displayed in the symbol display area 400, and it becomes easy to shift from high probability game 2 to the base game. In this way, it becomes difficult to shift from high probability game 2 to free game A.

As described above, when the first free game is free game A, a shift is made to free game B via high probability game 3 after free game A ends, and a shift is less likely to occur to free game A after free game B ends, and it becomes difficult to continue three times of the free game.

Note that, also in high probability game 2, when the bonus symbol B1 is won and three or four bonus symbols B1 are stop-displayed in the symbol display area 400, a shift condition is satisfied and a shift is made to free game A. The shift from high probability game 2 to free game A is uniquely determined. In a case where the first free game is free game A, when a shift is made to free game B via high probability game 3 after free game A ends, and a shift can be made to free game A after free game B ends, it becomes easy to shift to free game B again as described above, and four times of the free game are to be continued.

As described above, the free games of two times, four times, . . . are easy to continue, and the free games of three times, five times, . . . are difficult to continue.

### <Second Shift Continuation (Shift to Free Game C)>

In a case where a shift is made to high probability game 4, first, a symbol table for high probability game 4 is selected (see step S617 in FIG. 6, and FIG. 8). As described above, in high probability game 4, similarly to high probability game 3, the maximum number of times of re-spinning tends to be larger than that in high probability game 2 (see FIG. 14). Moreover, in high probability game 4 as well, a symbol table (RespinA) of re-spinning A is selected (see step S1217 in FIG. 12, and FIG. 8). Since the symbol table RespinA is used, the bonus symbol B1 is to be easily won.

Re-spinning is performed up to the maximum number of times of re-spinning. Every time re-spinning is performed, the symbol tables of RespinB, RespinC1, RespinC2, and RespinC3 are selected in accordance with the number of bonus symbols B1 stop-displayed in the symbol display area 400, and the bonus symbol B1 is to be more likely won. When three or four bonus symbols B1 are stop-displayed in the symbol display area 400, the symbol table (RespinE1 or RespinE2) of re-spinning C is selected, and the bonus symbol B1 is more likely to be won. When five bonus symbols B1 are stop-displayed in the symbol display area 400, a shift condition is established. A shift is made from high probability game 4 to free game C by the establishment of the shift condition. Note that the shift from high probability game 4 to free game C is uniquely determined.

<Shift from Free Game C to High Probability Game 4>

When the unit game is played up to a predetermined number of times in free game C, a shift condition is satisfied, and free game C shifts to high probability game 4. The shift from free game C to high probability game 4 is uniquely determined (see the numeral table of game shift lottery table 2 in FIG. 11B).

As described above, high probability game 4 easily shifts to free game C. Therefore, by a forward shift from high probability game 4 to free game C and a return shift from free game C to high probability game 4, the second shift continuation of reciprocating between high probability game 4 and free game C is realized. That is, two types of shift continuation different from each other are realized, which are the first shift continuation and the second shift continuation that is separate from the first shift continuation.

### <<<Free Game Processing>>>

FIG. 19 is a flowchart illustrating the free game processing. This processing is called and executed in step S633 of the normal game processing of FIG. 6. Note that, in the free game, a BET rate of the unit game immediately before shifting to the free game is maintained and used. Specifically, the BET rate stored in the RAM 130 (step S717 in FIG. 7) in the unit game of the normal game immediately before shifting to the free game is read and used.

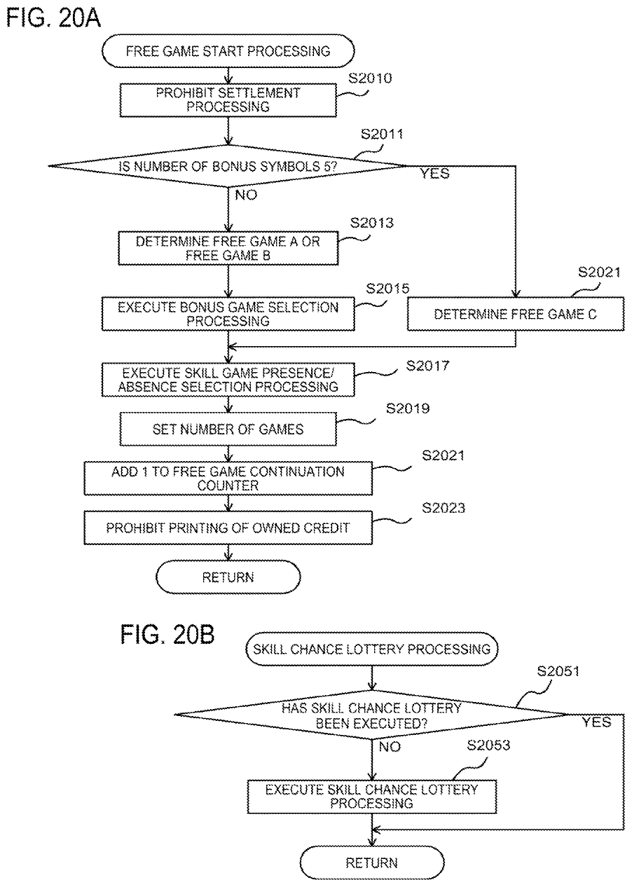

First, the CPU 110 of the controller 100 executes free game start processing illustrated in FIG. 20A (step S1911). In the free game start processing, determination of a type of the free game, selection of a type of the bonus game, selection of the presence or absence of the skill game, and the like are executed. Details of the free game start processing will be described later.

Next, the CPU 110 of the controller 100 executes unit game initialization processing (step S1913). For example, a symbol or the like determined by the lottery processing is initialized. As described above, a value of the BET rate in the normal game is maintained, and is not initialized in the free game.

Next, the CPU 110 of the controller 100 determines whether or not to execute a skill game in this unit game (step S1915). The skill game is executed when being selected by the player.

When the CPU 110 of the controller 100 determines not to execute the skill game in the determination processing of step S1915 (NO), 1 is subtracted from the number of free games (step S1917).

Next, when the CPU 110 of the controller 100 determines to execute the skill game in the determination processing of step S1915 (YES), or when the process of step S1917 is executed, a symbol table is selected in accordance with the type of the bonus game, the presence or absence of the skill game, and whether or not to execute the skill game (step S1919)

As described above, the bonus game includes eight types of games of: the lion bonus game (without a skill game); the gorilla bonus game (without a skill game); the ostrich bonus game (without a skill game); the elephant bonus game (without a skill game); the lion bonus game (with a skill game); the gorilla bonus game (with a skill game); the ostrich bonus game (with a skill game); and the elephant bonus game (with a skill game).

Moreover, four types of games of the lion bonus game (with a skill game), the gorilla bonus game (with a skill game), the ostrich bonus game (with a skill game), and the elephant bonus game (with a skill game) each include: a game before skill game start and a skill game.

Therefore, in the present embodiment, the symbol table used in the free game is defined for each of the 12 types of games of: the lion bonus game (without a skill game); the gorilla bonus game (without a skill game); the ostrich bonus game (without a skill game); the elephant bonus game (without a skill game); a game before skill game start of the lion bonus game (with a skill game); a skill game of the lion bonus game (with a skill game); a game before skill game start of the gorilla bonus game (with a skill game); a skill game of the gorilla bonus game (with a skill game); a game before skill game start of the ostrich bonus game (with a skill game); a skill game of the ostrich bonus game (with a skill game); a game before skill game start of the elephant bonus game (with a skill game); and a skill game of the elephant bonus game (with a skill game). The process of step S1919 is processing of selecting a symbol table according to these 12 types of games in accordance with the type of the bonus game, the presence or absence of the skill game, and whether or not to execute the skill game.

Next, the CPU 110 of the controller 100 executes the stop symbol lottery processing by using the symbol table selected in step S1919 (step S1921).

Next, the CPU 110 of the controller 100 determines whether or not a skill game has been selected in the process of step S2017 of FIG. 20A (step S1925)

When the CPU 110 of the controller 100 determines that the skill game has not been selected in the determination processing of step S1925 (NO), the multi-feature processing illustrated in FIG. 22 is executed (step S1927). The multi-feature processing is processing of, when a multi-feature is won, executing multi-feature allocation lottery processing and determining a special payout rate and the JACKPOT payout. Details of the multi-feature processing will be described later.

When the CPU 110 of the controller 100 determines that the skill game is selected in the determination processing of step S1925 (YES), skill chance lottery processing illustrated in FIG. 20B is executed (step S1923).

When the process of step S1923 or the process of step S1927 is executed, the CPU 110 of the controller 100 executes the scroll display control processing of FIG. 16 (step S1929).

Next, the CPU 110 of the controller 100 executes the discharge number determination processing of FIG. 17 (step S1931).

Next, the CPU 110 of the controller 100 determines whether or not the number of free games is 0 (step S1933).

When the CPU 110 of the controller 100 determines that the number of free games is not 0 (NO), the process returns to step S1913.

When the CPU 110 of the controller 100 determines that the number of free games is 0 (YES), the CPU 110 permit the cash-out processing (step S1935), and ends this subroutine. In this way, after the free game is ended, the owned credit can be printed by the ticket discharging device 270, and the play in the gaming machine 10 can be ended.

After the end of this subroutine, the process returns to any one of high probability games 1 to 4. The CPU 110 of the controller 100 returns the game to high probability game 3 when free game A ends, to high probability game 2 when free game B ends, and to high probability game 4 when free game C ends.

### <<<Free Game Start Processing>>>

FIG. 20A is a flowchart illustrating the free game start processing. This processing is called in step S1911 of the free game processing of FIG. 19.

First, the CPU 110 of the controller 100 prohibits the cash-out processing (step S2010).

Next, the CPU 110 of the controller 100 determines whether or not five bonus symbols B1 have been stop-displayed in the unit game of the normal game immediately before shifting to the free game (step S2011).

When the CPU 110 of the controller 100 determines that five bonus symbols B1 have not been stop-displayed in the determination processing of step S2011 (NO), the CPU 110 determines free game A or free game B in accordance with a type of the normal game immediately before shifting to the free game (step S2013).

Specifically, when the normal game immediately before shifting to the free game is the base game, the CPU 110 of the controller 100 selects free game A. When the normal game immediately before shifting to the free game is high probability game 1, the CPU 110 of the controller 100 selects free game A. When the normal game immediately before shifting to the free game is high probability game 2, the CPU 110 of the controller 100 selects free game A. When the normal game immediately before shifting to the free game is high probability game 3, the CPU 110 of the controller 100 selects free game B.

Next, the CPU 110 of the controller 100 displays a bonus game selection screen on the lower display 210, and determines the type of the bonus game selected by the player operating the touch panel 340 (step S2015). There are three types of bonus games that can be selected by the player in the process of step S2015, that is, the lion bonus game, the gorilla bonus game, and the ostrich bonus game, excluding the elephant bonus game. The player can select one of these types of bonus game.

When the CPU 110 of the controller 100 determines that five bonus symbols B1 have been stop-displayed in the determination processing of step S2011 (YES), free game C is determined (step S2021). Free game C has an elephant bonus game. Therefore, when five bonus symbols B1 are stop-displayed and a shift is made to the free game, free game C is selected without depending on the selection operation by the player, and the elephant bonus game is executed.

After executing the process of step S2015 or S2221, the CPU 110 of the controller 100 displays a selection screen for executing or not executing the skill game on the lower display 210, and determines execution or non-execution of the skill game selected by the player operating the touch panel 340 (step S2017). When the player selects execution of the skill game, the skill game is executed. Details of the skill game will be described later.

Next, the CPU 110 of the controller 100 sets the number of games in accordance with the type of the selected bonus game (step S2019). In the present embodiment, the number of games is set to 5 regardless of which one of the lion bonus game, the gorilla bonus game, the ostrich bonus game, and the elephant bonus game is selected.

Next, the CPU 110 of the controller 100 adds 1 to a free game continuation counter (step S2021). The free game continuation counter is a counter for counting the number of times the free game has been continued, when the free game continues.

Next, CPU 110 of the controller 100 prohibits printing of an owned credit by the ticket discharging device 270 (step S2023), and ends this subroutine.

### <<Skill Chance Lottery Processing>>

FIG. 20B is a flowchart illustrating the skill chance lottery processing. This processing is called in step S1923 of the free game processing of FIG. 19.

First, the CPU 110 of the controller 100 determines whether or not a skill chance lottery has already been executed (step S2051).

When the CPU 110 of the controller 100 determines that the skill chance lottery has not been executed yet (NO), the CPU 110 executes the skill chance lottery processing (step S2053), and ends the present subroutine. When the CPU 110 of the controller 100 determines that the skill chance lottery has already been executed (YES), the CPU 110 immediately ends this subroutine.

The skill chance lottery processing is executed on the condition that specific symbols are in a predetermined alignment along a valid pay line, on the basis of the stop symbol determined in the stop symbol lottery processing of step S1921. The predetermined alignment is an alignment in which only a part of a specific one winning combination among winning combinations is established. That is, there is a possibility that the specific one winning combination is established if the remaining specific symbol is stop-displayed (arranged) in the valid pay line. In other words, it is a winning combination incomplete establishment state immediately before a final state where the specific one winning combination is established. For example, the specific one winning combination is one in which the specific symbol is stop-displayed for each of all the video reels 410a to 410e, and the specific symbols are in a predetermined alignment along the valid pay line.

Specifically, there are cases, among the video reels 410a to 410e, where only the video reel 410a is not aligned, where only the video reel 410b is not aligned, where only the video reel 410c is not aligned, where only the video reel 410d is not aligned, or where only the video reel 410e is not aligned.

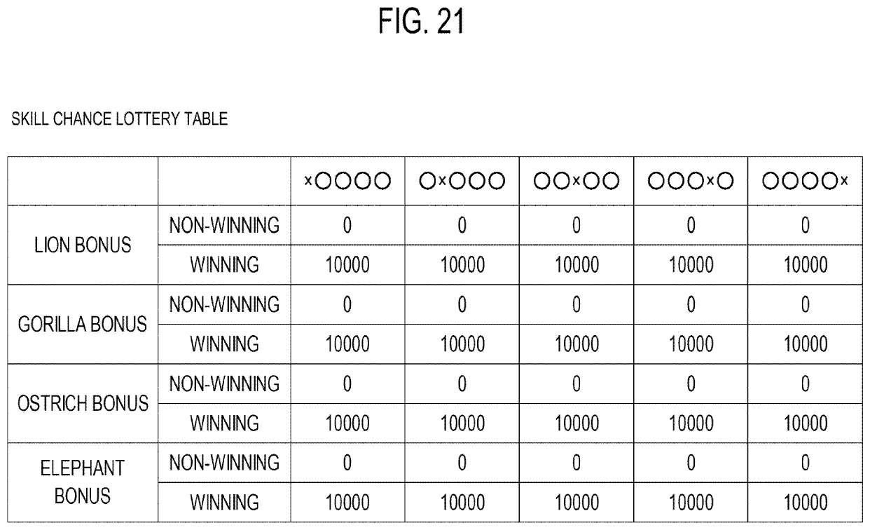

In the skill chance lottery processing, the lottery processing is executed in accordance with the type of the selected bonus game, and winning or non-winning of the skill chance is determined. FIG. 21 is a numeral table showing a likelihood of winning or non-winning of the skill chance. As illustrated in FIG. 21, numerals are determined for all of the case where only the video reel 410a is not aligned (x∘∘∘∘), the case where only the video reel 410b is not aligned (∘x∘∘∘), the case where only the video reel 410c is not aligned (∘∘x∘∘), the case where only the video reel 410d is not aligned (∘∘∘x∘), and the case where only the video reel 410e is not aligned (∘∘∘∘x). In the example of the numeral table shown in FIG. 21, a case where a skill chance is always won is illustrated. However, the numerals in the numeral table can be appropriately determined, and the skill chance may be made not to be won.

### <<<Multi-Feature Processing>>>

FIG. 22 is a flowchart illustrating the multi-feature processing. This processing is called in step S1927 of the free game processing of FIG. 19.

First, the CPU 110 of the controller 100 determines whether or not a winning combination of a specific symbol is established (step S2211).

When the CPU 110 of the controller 100 determines that the winning combination of the specific symbol is not established in the determination processing of step S2211 (NO), this subroutine is immediately ended.

When the CPU 110 of the controller 100 determines that the winning combination of the specific symbol is established in the determination processing of step S2211 (YES), multi-feature lottery processing is executed (step S2213).

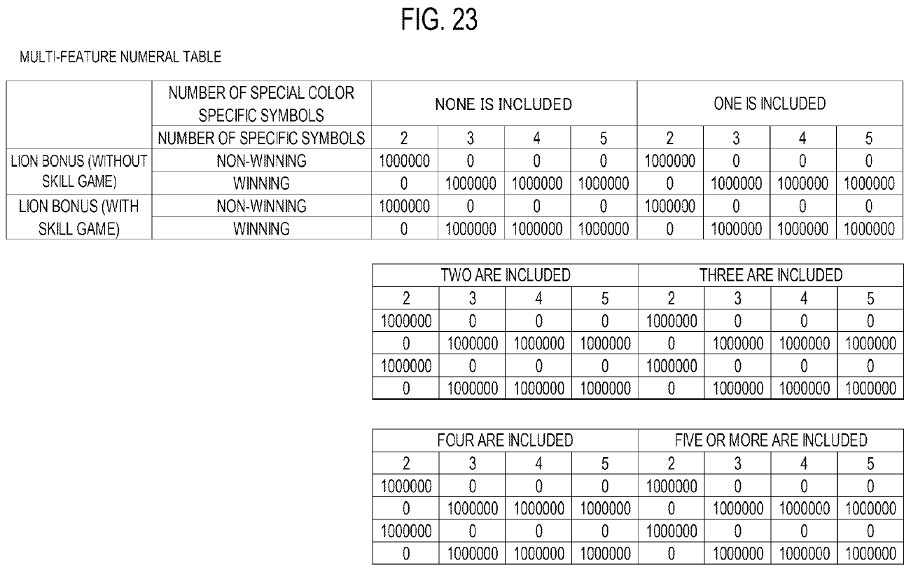

FIG. 23 is a numeral table of the multi-feature lottery processing, and illustrates a likelihood of winning or non-winning of a multi-feature. FIG. 23 illustrates a numeral table in a case where the skill game is not selected in the lion bonus game. For each of the lion bonus game, the gorilla bonus game, the ostrich bonus game, and the elephant bonus game, all the numeral tables are defined (not illustrated) for when the skill game is not selected and when the skill game is selected.

As illustrated in FIG. 23, the numerals of winning or non-winning of the multi-feature are determined in accordance with the number of special color specific symbols and the number of specific symbols, which are included in the established winning combination.

As shown in FIG. 23, in a case where no skill game is selected in the lion bonus game, regardless of the number of special color specific symbols, non-winning is always determined when the number of specific symbols is 2, and winning is always determined when the number of specific symbols is 3 to 5. In addition, even in a case where the skill game is selected in the lion bonus game, regardless of the number of special color specific symbols, non-winning is always determined when the number of specific symbols is 2, and winning is always determined when the number of specific symbols is 3 to 5 (not illustrated).

Moreover, the present embodiment is defined as follows. In the gorilla bonus game, in a case where no skill game is selected and a case where a skill game is selected, regardless of the number of special color specific symbols, winning is always determined when the number of specific symbols is 2 to 5. In the ostrich bonus game, in a case where no skill game is selected and a case where a skill game is selected, regardless of the number of special color specific symbols, non-winning is always determined when the number of specific symbols is 2 to 4, and winning is always determined when the number of specific symbols is 5.

In a case where no skill game is selected in the elephant bonus game, regardless of the number of special color specific symbols, winning is always determined when the number of specific symbols is 2 to 5. In a case where a skill game is selected in the elephant bonus game, regardless of the number of special color specific symbols, non-winning is always determined when the number of specific symbols is 2 to 4, and winning is always determined when the number of specific symbols is 5.

Next, the CPU 110 of the controller 100 determines whether or not the multi-feature has been won by the process of step S2213 (step S2215).

Next, when the CPU 110 of the controller 100 determines that the multi-feature has been won in the determination processing of step S2215 (YES), the CPU 110 initializes the number of times of JACKPOT winning (step S2217), and initializes the JACKPOT payout (step S2219).

Next, the CPU 110 of the controller 100 selects a multi-feature allocation lottery table in accordance with the number of times of JACKPOT winning (step S2221).

When the JACKPOT has not yet been won or has been won only once in the multi-feature allocation lottery in step S2223, a multi-feature allocation lottery table that enables winning of either the special payout rate or the JACKPOT payout is selected. Whereas, when the JACKPOT is won two times in the multi-feature allocation lottery, the multi-feature allocation lottery table that enables winning of only the special payout rate is selected. That is, the JACKPOT can be won up to two times, and when the JACKPOT is won two times, only the special payout rate is won.

Next, the CPU 110 of the controller 100 executes the multi-feature allocation lottery processing with reference to the multi-feature allocation lottery table selected in step S2221 (step S2223).

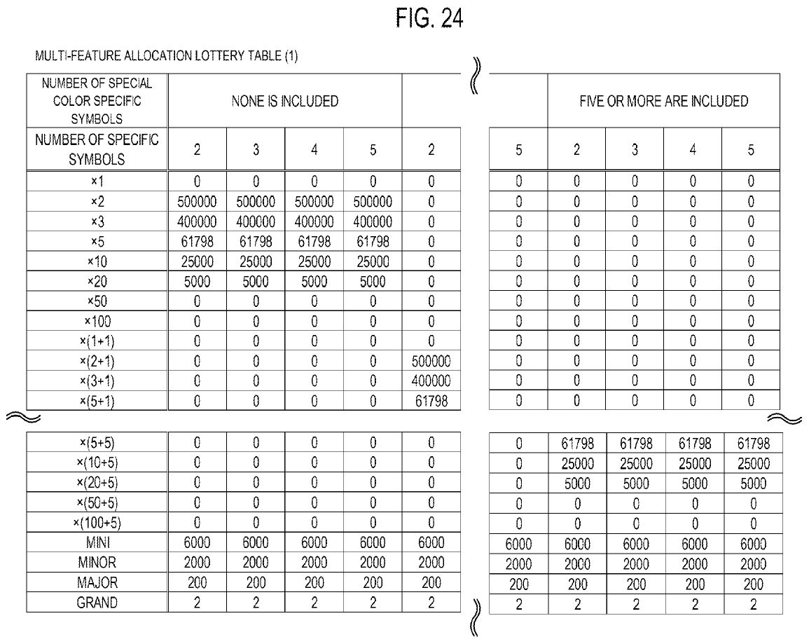

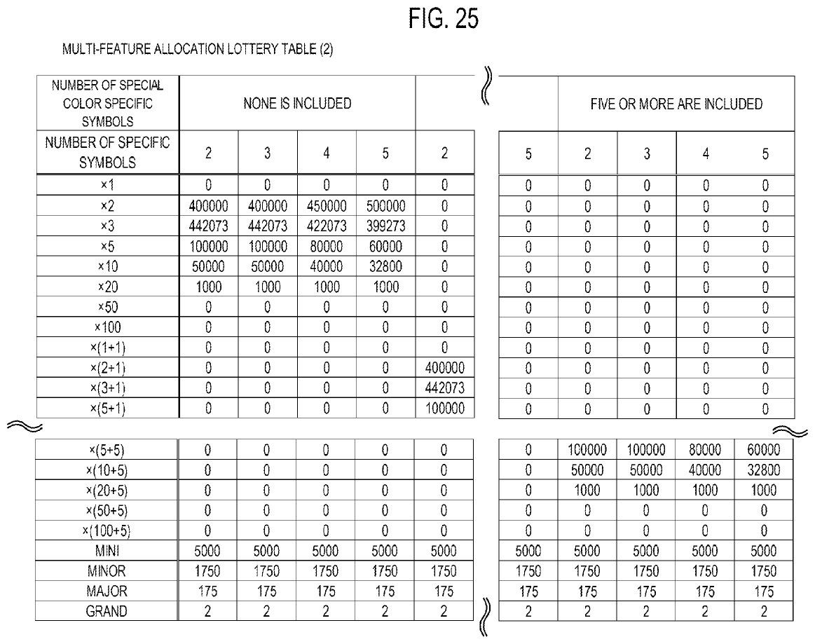

FIGS. 24 and 25 are numeral tables in the multi-feature allocation lottery processing, and illustrate a likelihood of winning or non-winning of the special payout rate or the JACKPOT payout. As illustrated in FIGS. 24 and 25, the numerals of winning or non-winning of the multi-feature are determined in accordance with the number of special color specific symbols and the number of specific symbols, which are included in the established winning combination.

Note that the numeral tables shown in FIGS. 24 and 25 are numeral tables when the lion bonus game is selected and the skill game is not selected in multi-feature allocation lottery processing of the first time, but the numeral table is also defined for other bonus games (presence or absence of skill games). That is, a numeral table at the time of the multi-feature allocation lottery processing is defined for 24 types of (L-1-1) to (E-3-2) below.

(L-1-1) First lottery processing, lion bonus game, without skill game

(L-2-1) Second lottery processing, lion bonus game, without skill game

(L-3-1) Third lottery processing, lion bonus game, without skill game

(G-1-1) First lottery processing, gorilla bonus game, without skill game

(G-2-1) Second lottery processing, gorilla bonus game, without skill game

(G-3-1) Third lottery processing, gorilla bonus game, without skill game

(O-1-1) First lottery processing, ostrich bonus game, without skill game

(O-2-1) Second lottery processing, ostrich bonus game, without skill game

(O-3-1) Third lottery processing, ostrich bonus game, without skill game

(E-1-1) First lottery processing, elephant bonus game, without skill game

(E-2-1) Second lottery processing, elephant bonus game, without skill game

(E-3-1) Third lottery processing, elephant bonus game, without skill game

(L-1-2) First lottery processing, lion bonus game, with skill game

(L-2-2) Second lottery processing, lion bonus game, with skill game

(L-3-2) Third lottery processing, lion bonus game, with skill game

(G-1-2) First lottery processing, gorilla bonus game, with skill game

(G-2-2) Second lottery processing, gorilla bonus game, with skill game

(G-3-2) Third lottery processing, gorilla bonus game, with skill game

(O-1-2) First lottery processing, ostrich bonus game, with skill game

(O-2-2) Second lottery processing, ostrich bonus game, with skill game

(O-3-2) Third lottery processing, ostrich bonus game, with skill game

(E-1-2) First lottery processing, elephant bonus game, with skill game

(E-2-2) Second lottery processing, elephant bonus game, with skill game

(E-3-2) Third lottery processing, elephant bonus game, with skill game

As described above, in any of the numeral tables (L-3-1), (G-3-1), (O-3-1), and (E-3-1) in the third lottery processing, the JACKPOT payout is not to be won.

The special payout rate is determined in accordance with the number of special color specific symbols included in the established winning combination. The special payout rate is: (1+the number of special color specific symbols) times; (2+the number of special color specific symbols) times; (3+the number of special color specific symbols) times; (5+the number of special color specific symbols) times; (10+the number of special color specific symbols) times; (20+the number of special color specific symbols) times; (50+the number of special color specific symbols) times; and (100+the number of special color specific symbols) times. For example, when the number of special color specific symbols included in the established winning combination is 0, the special payout rates are to be 1 time, 2 times, 3 times, 5 times, 10 times, 20 times, 50 times, and 100 times, individually. Further, when the number of special color specific symbols included in the established winning combination is 3, the special payout rates are to be (1+3) times, (2+3) times, (3+3) times, (5+3) times, (10+3) times, (20+3) times, (50+3) times, and (100+3) times.

In addition, as the JACKPOT payout, numerals are defined for four types of MINI, MINOR, MAJOR, and GRAND.

In a numeral table for (L-1-1) in the lion bonus game, regardless of the number of special color specific symbols, for all in which the number of specific symbols is 2 to 5, a numeral for (1+the number of special color specific symbols) times is 0, a numeral for (2+the number of special color specific symbols) times is 500000, a numeral for (3+the number of special color specific symbols) times is 400000, a numeral for (5+the number of special color specific symbols) times is 61798, a numeral for (10+the number of special color specific symbols) times is 25000, a numeral for (20+the number of special color specific symbols) times is 5000, a numeral for (50+the number of special color specific symbols) times is 0, a numeral for (100+the number of special color specific symbols) times is 0, a numeral for MINI is 6000, a numeral for MINOR is 2000, a numeral for MAJOR is 200, and a numeral for GRAND is 2.

In a numeral table for (L-2-1) in the lion bonus game, regardless of the number of special color specific symbols, for all in which the number of specific symbols is 2 to 5, a numeral for (1+the number of special color specific symbols) times is 0, a numeral for (2+the number of special color specific symbols) times is 508073, a numeral for (3+the number of special color specific symbols) times is 400000, a numeral for (5+the number of special color specific symbols) times is 61798, a numeral for (10+the number of special color specific symbols) times is 25000, a numeral for (20+the number of special color specific symbols) times is 5000, a numeral for (50+the number of special color specific symbols) times is 0, a numeral for (100+the number of special color specific symbols) times is 0, a numeral for MINI is 100, a numeral for MINOR is 25, a numeral for MAJOR is 3, and a numeral for GRAND is 1.

In a numeral table for (L-3-1) in the lion bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 1000000, a numeral for (20+the number of special color specific symbols) times is 0, a numeral for (50+the number of special color specific symbols) times is 0, a numeral for (100+the number of special color specific symbols) times is 0, a numeral for MINI is 0, a numeral for MINOR is 0, a numeral for MAJOR is 0, and a numeral for GRAND is 0.

In a numeral table for (G-1-1) in the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 875000, a numeral for (3+the number of special color specific symbols) times is 115899, a numeral for (5+the number of special color specific symbols) times is 0, a numeral for (10+the number of special color specific symbols) times is 5000, a numeral for (20+the number of special color specific symbols) times is 0, a numeral for (50+the number of special color specific symbols) times is 0, a numeral for (100+the number of special color specific symbols) times is 0, a numeral for MINI is 3000, a numeral for MINOR is 1000, a numeral for MAJOR is 100, and a numeral for GRAND is 1.

In a numeral table for (G-2-1) in the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 878972, a numeral for (3+the number of special color specific symbols) times is 115899, a numeral for (5+the number of special color specific symbols) times is 0, a numeral for (10+the number of special color specific symbols) times is 5000, a numeral for (20+the number of special color specific symbols) times is 0, a numeral for (50+the number of special color specific symbols) times is 0, a numeral for (100+the number of special color specific symbols) times is 0, a numeral for MINI is 100, a numeral for MINOR is 25, a numeral for MAJOR is 3, and a numeral for GRAND is 1.

In a numeral table of (G-3-1) of the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, and a numeral for (10+the number of special color specific symbols) times is 1000000.

A numeral for (20+the number of special color specific symbols) times is 0, a numeral for (50+the number of special color specific symbols) times is 0, a numeral for (100+the number of special color specific symbols) times is 0, a numeral for MINI is 0, a numeral for MINOR is 0, a numeral for MAJOR is 0, and a numeral for GRAND is 0.

In a numeral table for (O-1-1) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 500000, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 10500, a numeral for MINOR is 3500, a numeral for MAJOR is 500, and a numeral for GRAND is 3.

In a numeral table for (O-2-1) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 514374, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 100, a numeral for MINOR is 25, a numeral for MAJOR is 3, and a numeral for GRAND is 1.

In a numeral table for (O-3-1) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 0, a numeral for (20+the number of special color specific symbols) times is 0, a numeral for (50+the number of special color specific symbols) times is 0, a numeral for (100+the number of special color specific symbols) times is 1000000, a numeral for MINI is 0, a numeral for MINOR is 0, a numeral for MAJOR is 0, and a numeral for GRAND is 0.

In a numeral table for (E-1-1) in the elephant bonus game, regardless of the number of special color specific symbols, for all in which the number of specific symbols is 2 to 5, a numeral for (1+the number of special color specific symbols) times is 0, a numeral for (2+the number of special color specific symbols) times is 400000, a numeral for (3+the number of special color specific symbols) times is 406574, a numeral for (5+the number of special color specific symbols) times is 132000, a numeral for (10+the number of special color specific symbols) times is 50000, a numeral for (20+the number of special color specific symbols) times is 4000, a numeral for (50+the number of special color specific symbols) times is 250, a numeral for (100+the number of special color specific symbols) times is 250, a numeral for MINI is 5000, a numeral for MINOR is 1750, a numeral for MAJOR is 175, and a numeral for GRAND is 1.

In a numeral table for (E-2-1) in the elephant bonus game, regardless of the number of special color specific symbols, for all in which the number of specific symbols is 2 to 5, a numeral for (1+the number of special color specific symbols) times is 0, a numeral for (2+the number of special color specific symbols) times is 406926, a numeral for (3+the number of special color specific symbols) times is 406574, a numeral for (5+the number of special color specific symbols) times is 132000, a numeral for (10+the number of special color specific symbols) times is 50000, a numeral for (20+the number of special color specific symbols) times is 4000, a numeral for (50+the number of special color specific symbols) times is 250, a numeral for (100+the number of special color specific symbols) times is 250, a numeral for MINI is 0, a numeral for MINOR is 0, a numeral for MAJOR is 0, and a numeral for GRAND is 0.

In a numeral table for (E-3-1) in the elephant bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 0, a numeral for (20+the number of special color specific symbols) times is 0, a numeral for (50+the number of special color specific symbols) times is 0, a numeral for (100+the number of special color specific symbols) times is 1000000, a numeral for MINI is 0, a numeral for MINOR is 0, a numeral for MAJOR is 0, and a numeral for GRAND is 0.

In a numeral table for (L-1-2) in the lion bonus game, regardless of the number of special color specific symbols, for all in which the number of specific symbols is 2 to 5, a numeral for (1+the number of special color specific symbols) times is 0, a numeral for (2+the number of special color specific symbols) times is 400000, a numeral for (3+the number of special color specific symbols) times is 442073, a numeral for (5+the number of special color specific symbols) times is 100000, a numeral for (10+the number of special color specific symbols) times is 50000, a numeral for (20+the number of special color specific symbols) times is 1000, a numeral for (50+the number of special color specific symbols) times is 0, a numeral for (100+the number of special color specific symbols) times is 0, a numeral for MINI is 5000, a numeral for MINOR is 1750, a numeral for MAJOR is 175, and a numeral for GRAND is 2.

In a numeral table for (L-2-2) in the lion bonus game, regardless of the number of special color specific symbols, for all in which the number of specific symbols is 2 to 5, a numeral for (1+the number of special color specific symbols) times is 0, a numeral for (2+the number of special color specific symbols) times is 407766, a numeral for (3+the number of special color specific symbols) times is 442073, a numeral for (5+the number of special color specific symbols) times is 100000, a numeral for (10+the number of special color specific symbols) times is 50000, a numeral for (20+the number of special color specific symbols) times is 0, a numeral for (50+the number of special color specific symbols) times is 0, a numeral for (100+the number of special color specific symbols) times is 0, a numeral for MINI is 100, a numeral for MINOR is 50, a numeral for MAJOR is 10, and a numeral for GRAND is 1.

In a numeral table of (L-3-2) of the lion bonus game, regardless of the number of special color specific symbols, for all in which the number of specific symbols is 2 to 5, a numeral for (1+the number of special color specific symbols) times is 0, a numeral for (2+the number of special color specific symbols) times is 0, and a numeral for (3+the number of special color specific symbols) times is 0.

A numeral for (5+the number of special color specific symbols) times is 0, a numeral for (10+the number of special color specific symbols) times is 1000000, a numeral for (20+the number of special color specific symbols) times is 0, a numeral for (50+the number of special color specific symbols) times is 0, a numeral for (100+the number of special color specific symbols) times is 0, a numeral for MINI is 0, a numeral for MINOR is 0, a numeral for MAJOR is 0, and a numeral for GRAND is 0.

In a numeral table for (G-1-2) in the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 875000, a numeral for (3+the number of special color specific symbols) times is 113399, a numeral for (5+the number of special color specific symbols) times is 0, a numeral for (10+the number of special color specific symbols) times is 7500, a numeral for (20+the number of special color specific symbols) times is 0, a numeral for (50+the number of special color specific symbols) times is 0, a numeral for (100+the number of special color specific symbols) times is 0, a numeral for MINI is 3000, a numeral for MINOR is 1000, a numeral for MAJOR is 100, and a numeral for GRAND is 1.

In a numeral table for (G-2-2) in the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 878940, a numeral for (3+the number of special color specific symbols) times is 113399, a numeral for (5+the number of special color specific symbols) times is 0, a numeral for (10+the number of special color specific symbols) times is 7500, a numeral for (20+the number of special color specific symbols) times is 0, a numeral for (50+the number of special color specific symbols) times is 0, a numeral for (100+the number of special color specific symbols) times is 0, a numeral for MINI is 100, a numeral for MINOR is 50, a numeral for MAJOR is 10, and a numeral for GRAND is 1.

In a numeral table for (G-3-2) in the gorilla bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 1000000, a numeral for (20+the number of special color specific symbols) times is 0, a numeral for (50+the number of special color specific symbols) times is 0, a numeral for (100+the number of special color specific symbols) times is 0, a numeral for MINI is 0, a numeral for MINOR is 0, a numeral for MAJOR is 0, and a numeral for GRAND is 0.

In a numeral table for (O-1-2) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 500000, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 10500, a numeral for MINOR is 3500, a numeral for MAJOR is 500, and a numeral for GRAND is 3.

In a numeral table for (O-2-2) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 514342, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 100, a numeral for MINOR is 50, a numeral for MAJOR is 10, and a numeral for GRAND is 1.

In a numeral table for (O-3-2) in the ostrich bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 0, a numeral for (20+the number of special color specific symbols) times is 0, a numeral for (50+the number of special color specific symbols) times is 0, a numeral for (100+the number of special color specific symbols) times is 1000000, a numeral for MINI is 0, a numeral for MINOR is 0, a numeral for MAJOR is 0, and a numeral for GRAND is 0.

In a numeral table for (E-1-2) in the elephant bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 500000, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 10500, a numeral for MINOR is 3500, a numeral for MAJOR is 500, and a numeral for GRAND is 3.

In a numeral table for (E-2-2) in the elephant bonus game, regardless of the number of special color specific symbols, for all in which the number of specific symbols is 2 to 5, a numeral for (+the number of special color specific symbols) times is 0, a numeral for (2+the number of special color specific symbols) times is 0, a numeral for (3+the number of special color specific symbols) times is 514342, a numeral for (5+the number of special color specific symbols) times is 378497, a numeral for (10+the number of special color specific symbols) times is 70000, a numeral for (20+the number of special color specific symbols) times is 35000, a numeral for (50+the number of special color specific symbols) times is 1000, a numeral for (100+the number of special color specific symbols) times is 1000, a numeral for MINI is 100, a numeral for MINOR is 50, a numeral for MAJOR is 10, and a numeral for GRAND is 1.

In a numeral table for (E-3-2) in the elephant bonus game, regardless of the number of special color specific symbols, for all in which the number of specific symbols is 2 to 5, a numeral for (1+the number of special color specific symbols) times is 0, a numeral for (2+the number of special color specific symbols) times is 0, a numeral for (3+the number of special color specific symbols) times is 0, a numeral for (5+the number of special color specific symbols) times is 0, a numeral for (10+the number of special color specific symbols) times is 0, a numeral for (20+the number of special color specific symbols) times is 0, a numeral for (50+the number of special color specific symbols) times is 0, a numeral for (100+the number of special color specific symbols) times is 1000000, a numeral for MINI is 0, a numeral for MINOR is 0, a numeral for MAJOR is 0, and a numeral for GRAND is 0.

### <Special Payout Rate>

In the lion bonus game, regardless of the presence or absence of the skill game, 2 times and 3 times are likely to be won, and 5 times, 10 times, and 20 times may be won. In the lion bonus game, 1 time, 50 times, and 100 times are not to be won. In the third lottery processing, only 10 times is won.

In the gorilla bonus game, regardless of the presence or absence of the skill game, 2 times is likely to be won, and 3 times and 10 times may be won. In the gorilla bonus game, 1 time, 5 times, 20 times, 50 times, and 100 times are not to be won. In the third lottery processing, only 10 times is won.

In the ostrich bonus game, regardless of the presence or absence of the skill game, 3 times is likely to be won, and 5 times, 10 times, 20 times, 50 times, and 100 times may be won. In the ostrich bonus game, 1 time and 2 times are not to be won. In the third lottery processing, only 100 times is won.

In the elephant bonus game, when there is no skill game, 3 times is likely to be won, and 5 times, 10 times, 20 times, 50 times, and 100 times may be won. In the elephant bonus game, 1 time is not to be won. In the third lottery processing, only 100 times is won. In the elephant bonus game, when there is a skill game, 3 times is likely to be won, and 5 times, 10 times, 20 times, 50 times, and 100 times may be won. In the elephant bonus game, 1 time and 2 times are not to be won. In the third lottery processing, only 100 times is won.

### <JACKPOT Payout>

The JACKPOT payout decreases as the number of lotteries increases in any of the lion bonus game, the gorilla bonus game, the ostrich bonus game, and the elephant bonus game.

When there is no skill game, the JACKPOT payout is largest in the ostrich bonus game, second largest in the lion bonus game, and third largest in the elephant bonus game, and smallest in the gorilla bonus game.

When there is a skill game, the JACKPOT payout is largest in the ostrich bonus game and the elephant bonus game, second largest in the lion bonus game, and smallest in the gorilla bonus game.

The JACKPOT payout in the lion bonus game is smaller when there is a skill game than when there is no skill game, and the JACKPOT payout in the elephant bonus game is larger when there is a skill game than when there is no skill game. In addition, in other gorilla bonus game and ostrich bonus game, the JACKPOT payout has the same numeral when there is a skill game and when there is no skill game.

After executing the process of step S2223 described above, the CPU 110 of the controller 100 determines whether or not the JACKPOT is won in the multi-feature allocation lottery processing of step S2223 (step S2225).

When the CPU 110 of the controller 100 determines that the JACKPOT is not won in the determination processing of step S2225 (NO), the CPU 110 stores, in the RAM 130, the special payout rate won in the multi-feature allocation lottery processing (step S2227), and ends this subroutine.

When the CPU 110 of the controller 100 determines that the JACKPOT is won in the determination processing of step S2225 (YES), the CPU 110 adds the JACKPOT payout won in the multi-feature allocation lottery processing (step S2229), adds 1 to the number of times of JACKPOT winning (step S2231), and returns the process to step S2221. As described above, the multi-feature allocation lottery table is selected in accordance with the number of times of JACKPOT winning.

### <<<Outline of Skill Game>>>

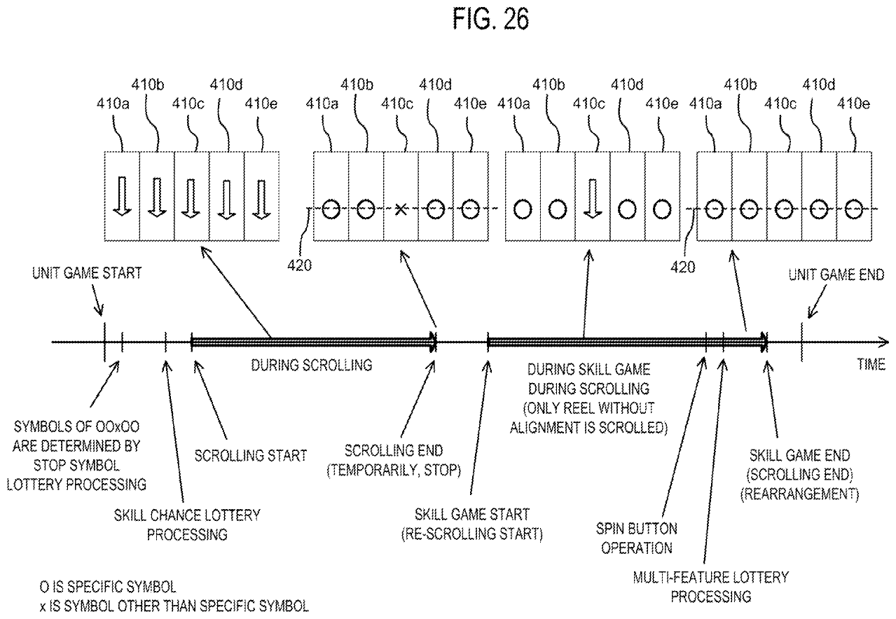

As described above, in the free game, when the player selects a skill game, the skill game is executed. FIG. 26 is a time chart illustrating a rough flow of the skill game.

First, when a unit game starts, the stop symbol lottery processing is executed to determine a stop symbol in step S1921 of FIG. 19. On the basis of the stop symbol, the specific symbols are to be in a predetermined alignment (“∘∘x∘∘” in FIG. 26) along a valid pay line. Note that “∘” indicates a specific symbol, and “x” indicates a symbol other than the specific symbol. As described above, the predetermined alignment is an incomplete alignment immediately before a final state of establishment of a winning combination.

Next, in step 1923 of FIG. 19, the skill chance lottery processing is executed to win a skill chance.

Next, scrolling of the video reels 410a to 410e is started, and after a predetermined time has elapsed, all the video reels 410a to 410e are stopped. By stopping the video reel 410, a predetermined alignment of specific symbols “∘∘x∘∘” is stop-displayed in the symbol display area 400 along the valid pay line. In this example, a symbol of the video reel 410c is not the specific symbol.

Next, the skill game is started, and only the video reel 410c on which the specific symbol has not been stop-displayed is re-scrolled. The player operates the SPIN button 330 such that specific symbols are aligned along the valid pay line.

Next, by a stop operation by the player, the video reel 410c stops, and specific symbols are stop-displayed in the symbol display area 400 and aligned along the valid pay line, a winning combination of the specific symbol is established, a corresponding payout is paid, the skill game ends, and the unit game ends.

### <<<Cash-Out Processing>>>

When the normal game is being played, a ticket can be printed out and cash-out can be performed in any of the base game, high probability game 1, high probability game 2, high probability game 3, and high probability game 4. Whereas, when the free game is being played, the cash-out cannot be performed for any of free game A, free game B, and free game C.

### <<<Display of Payout Earned in Free Game>>>

When the free game ends, the earned payout is displayed on the lower display 210, the upper display 220, or the like in any of free game A, free game B, and free game C. Moreover, in a case where the first shift continuation or the second shift continuation described above is performed, the number of shifts is counted when a shift is made to free game A, free game B, and free game C, and the earned payout is added to a total number when free game A, free game B, and free game C are ended. When a shift cannot be made to free game A, free game B, and free game C, and a shift is made from high probability game 1, high probability game 2, high probability game 3, or high probability game 4 to the base game, the total number of payouts earned by the first shift continuation or the second shift continuation and the number of times of continuation may be indicated to the player, by displaying the total number of earned payouts and the number of shifts on the lower display 210, the upper display 220, or the like. Note that, by initializing the number of shifts at the time of shifting from high probability game 1, high probability game 2, high probability game 3, or high probability game 4 to the base game, the number of times of continuation can be cleared.

<<<Game shift Processing>>>

FIG. 27 is a flowchart illustrating the game shift processing. This processing is called and executed in step S628 of the normal game processing of FIG. 6.

First, the CPU 110 of the controller 100 determines whether or not to shift to the base game (step S2711).

When the CPU 110 of the controller 100 determines not to shift to the base game (NO), this subroutine is immediately ended.

Whereas, when the CPU 110 of the controller 100 determines to shift to the base game (YES), the CPU 110 determines whether or not the value of the free game continuation counter is larger than 0 (step S2713).

When the CPU 110 of the controller 100 determines to shift to the base game (YES), when the CPU 110 determines that the value of the free game continuation counter is 0 or less (NO), this subroutine is immediately ended. That is, when the free game has not been continued, this subroutine is immediately ended.

When the CPU 110 of the controller 100 determines to shift to the base game (YES), when the CPU 110 determines that the value of the free game continuation counter is larger than 0 (YES), that is, when the free game has been continued so far, but the free game cannot be newly continued and a shift is made to the base game, the number of free game continuation total discharge credits is displayed on the lower display 210 (step S2715). By displaying the number of free game continuation total discharge credits, it is possible to make the player visually recognize all the numbers of discharge credits that can be earned in the continued free game.

Next, the CPU 110 of the controller 100 initializes the free game continuation counter (step S2717), initializes the number of free game continuation total discharge credits (step S2719), and ends this subroutine.

### <<<JACKPOT Accumulation Processing>>>

FIG. 28 is a flowchart illustrating JACKPOT accumulation processing. This processing is called and executed in step S725 of the BET processing and the SPIN button processing of FIG. 7. The JACKPOT accumulation processing in FIG. 28 is commonly executed in both the normal game and the free game.

First, the CPU 110 of the controller 100 calculates an additional value to be added to the JACKPOT accumulation payout (step S2811).

Next, the CPU 110 of the controller 100 adds the additional value to the JACKPOT accumulation payout and stores in a predetermined storage area (step S2813), and ends this subroutine.

### <<<JACKPOT Processing>>>

By the process of FIG. 28 described above, the JACKPOT accumulation processing is executed. With the JACKPOT accumulation processing, a predetermined accumulation value (number of accumulation credits) is accumulated in the JACKPOT accumulation payout at a predetermined timing, for example, every time a unit game is played. When a predetermined condition is satisfied, the accumulated JACKPOT accumulation payout is discharged. For example, in the present embodiment, as illustrated in FIG. 18, when the JACKPOT is won, the JACKPOT accumulation payout is discharged.

The accumulation value can be made constant regardless of a BET rate. That is, the accumulation value can be made constant in both a minimum BET (for example, the “BET×1” button 320a is operated) and a maximum BET (for example, the “BET×5” button 320e is operated. In this case, if the JACKPOT is won while the game is being played with the minimum BET, the discharge credit can be made larger than an input credit. This is more likely to be advantageous than when the game is being played with the maximum BET, and may cause unfairness.

Therefore, by adjusting a winning probability so as to make the JACKPOT more likely to be won when the game is being played with the maximum BET than when the game is being played with the minimum BET, it is possible to resolve the unfairness due to the BET rate.

However, in such a configuration, it is necessary to change the winning probability of the JACKPOT in accordance with the BET rate. Moreover, in a case where the winning of the JACKPOT is determined on the basis of a result of the symbol lottery processing, it is necessary to switch the symbol table in accordance with the BET rate. Therefore, the processing becomes complicated, and it is also necessary to store a large number of symbol tables in the storage device 140. Hereinafter, processing for making the probability of winning of the JACKPOT constant without depending on the BET rate will be described.

### <<JACKPOT Accumulation Processing 1>>

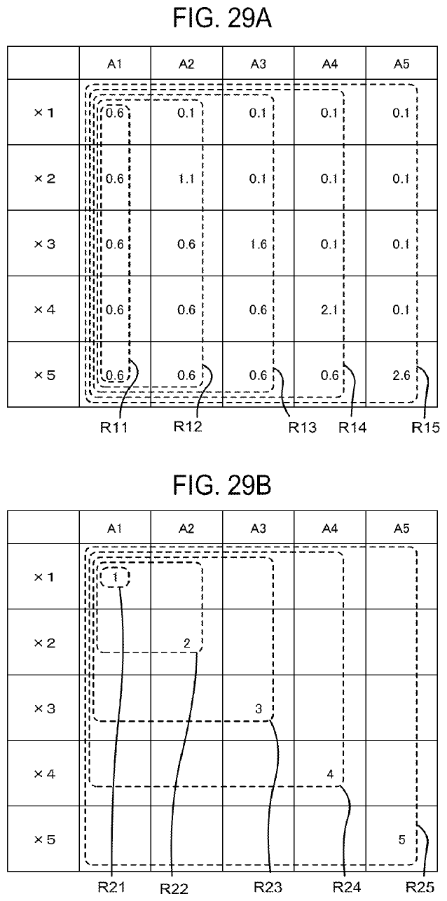

A ratio of an accumulation value accumulated in the JACKPOT accumulation payout is changed in accordance with the BET rate. FIG. 29A is a conceptual view illustrating a storage area of the RAM 130 for storage of the JACKPOT accumulation payout. A1 to A5 illustrated in FIG. 29A are storage areas of the RAM 130 for storage of the JACKPOT accumulation payout. ×1 to ×5 shown in FIG. 29A indicate the BET rates. Numerical values shown in individual cells of FIG. 29A are the ratios of the accumulation value.

In any case where the BET rate is ×1 to ×5, a predetermined accumulation value is accumulated in all the areas of the storage areas A1 to A5. When the BET rate is ×1, the accumulation value corresponding to the ratio is accumulated in all of the storage areas A1 to A5 corresponding to the BET rate of ×1. Similarly, when the BET rate is ×3, the accumulation value corresponding to the ratio is accumulated in all of the storage areas A1 to A5 corresponding to the BET rate of ×3. In this manner, the ratio of accumulation in the storage areas A1 to A5 is changed in accordance with the BET rate, and the accumulation value is accumulated.

Specifically, when the BET rate of ×1, which is the minimum BET, the accumulation value of a largest ratio (0.6%) is accumulated in the storage area A1, and the accumulation value of a small ratio (0.1%) is accumulated in each of the remaining storage areas A2 to A5. Further, when the BET rate of ×5, which is the maximum BET, the accumulation value of a largest ratio (2.6%) is accumulated in the storage area A5, and the accumulation value of a small ratio (0.6%) is accumulated in each of the remaining storage areas A1 to A4.

In a case where the JACKPOT is won when the BET rate is ×1, all the JACKPOT accumulation payouts in the storage area A1 are discharged (R11). In a case where the JACKPOT is won when the BET rate is ×2, all the JACKPOT accumulation payouts in the storage areas A1 and A2 are discharged (R12). In a case where the JACKPOT is won when the BET rate is ×3, all the JACKPOT accumulation payouts in the storage areas A1 to A3 are discharged (R13). In a case where the JACKPOT is won when the BET rate is ×4, all the JACKPOT accumulation payouts in the storage areas A1 to A4 are discharged (R14). In a case where the JACKPOT is won when the BET rate is ×5, all the JACKPOT accumulation payouts in the storage areas A1 to A5 are discharged (R15).

In this way, it is possible to eliminate unfairness while keeping the probability of winning of the JACKPOT constant.

### <<JACKPOT Accumulation Processing 2>>

Furthermore, the following can also be adopted. FIG. 29B is a conceptual view illustrating a storage area of the RANI 130 for storage of the JACKPOT accumulation payout. A1 to A5 illustrated in FIG. 29B are storage areas of the RAM 130 for storage of the JACKPOT accumulation payout. ×1 to ×5 shown in FIG. 29B indicate the BET rates. Numerical values shown in individual cells of FIG. 29B are the ratios of the accumulation value.

When the BET rate is ×1, an accumulation value corresponding to the ratio (1%) is accumulated only in the storage area A1 of the BET rate ×1. When the BET rate is ×2, an accumulation value corresponding to the ratio (2%) is accumulated only in the storage area A2 of the BET rate ×2. When the BET rate is ×3, an accumulation value corresponding to the ratio (3%) is accumulated only in the storage area A3 of the BET rate ×3. When the BET rate is ×4, an accumulation value corresponding to the ratio (4%) is accumulated only in the storage area A4 of the BET rate ×4. When the BET rate is ×5, an accumulation value corresponding to the ratio (5%) is accumulated only in the storage area A5 of the BET rate ×5.

In a case where the JACKPOT is won when the BET rate is ×1, JACKPOT accumulation payouts in the storage area A1 are discharged (R21). In a case where the JACKPOT is won when the BET rate is ×2, JACKPOT accumulation payouts in the storage areas A1 and A2 are discharged (R22). In a case where the JACKPOT is won when the BET rate is ×3, JACKPOT accumulation payouts in the storage areas A1 to A3 are discharged (R23). In a case where the JACKPOT is won when the BET rate is ×4, JACKPOT accumulation payouts in the storage areas A1 to A4 are discharged (R24).

In a case where the JACKPOT is won when the BET rate is ×5, JACKPOT accumulation payouts in the storage areas A1 to A5 are discharged (R25).

In this way, it is possible to eliminate unfairness while keeping the probability of winning of the JACKPOT constant.

### Details of Present Embodiment

As described above, the present invention has been described according to the present embodiment, but it should not be understood that the description and drawings constituting a part of this disclosure limit the present invention. Although specific numerical values are shown in the lottery table for understanding, the numerical values are not limited to the numerical values shown in the lottery table and may be any desired numerical values in order to change the game performance. As described above, it is a matter of course that the present invention includes various embodiments and the like not described herein.

### REFERENCE SIGNS LIST

10 gaming machine
100 controller
210 lower display
320a, 320b, 320c, 320d, 320e BET button
330 SPIN button
400 symbol display area

1. A gaming machine comprising:
an operation reception device configured to receive an operation by a player;
a display configured to display a game result by scrolling a video reel on which a plurality of symbols are aligned, and then rearranging the plurality of symbols; and
a controller configured to execute a base game and a plurality of chance games that require betting, and a plurality of free games that require no betting, wherein
the controller executes, during execution of a free game, a skill game in which a video reel being scrolled is stopped in accordance with an operation by a player on the operation reception device.

2. The gaming machine according to claim 1, further comprising:
a memory that stores reel data of a normal video reel for stop-display of a normal symbol and reel data of a specific video reel for stop-display of a specific symbol different from the normal symbol, the specific video reel being for stop-display of the specific symbol without depending on a timing of an operation by a player on an operation reception device, wherein
each of the plurality of free games includes a plurality of times of a unit game, and
the skill game is a game of:
switching to the specific video reel and scrolling the specific video reel on condition that, in one unit game in a free game, the specific symbol stop-displayed when the normal video reel is temporarily stopped after being scrolled is in a predetermined alignment; and then stopping the specific video reel in accordance with an operation by a player on the operation reception device and rearranging the plurality of symbols to establish a winning combination of the specific symbol.

3. The gaming machine according to claim 1, wherein
the specific symbol includes a normal specific symbol having a normal form and a special specific symbol having a special form, and
in a skill game,
when a winning combination of only the normal specific symbol is established, a first payout is granted, and
when a winning combination of the special specific symbol and the normal specific symbol is established, a second payout more advantageous than the first payout is granted.

4. The gaming machine according to claim 1, wherein, whether or not to execute the skill game is selected by an operation by a player on the operation reception device.
